(19) United States
(12) Patent Application Publication
(10) Pub. No.: US 2004/0073434 A1
(43) Pub. Date: Apr. 15, 2004

(54) Automobile repair estimation method apparatus, and system

(76) Inventors: Jerry A. Volquardsen, Grimes, IA (US); Keith L. Volquardsen, Urbandale, IA (US); Michael R. Thorson, Clive, IA (US)

Correspondence Address: MCKEE, VOORHEES & SEASE, P.L.C., 801 GRAND AVENUE, SUITE 3200, DES MOINES, IA, 50309-2721, US

(21) Appl. No.: 09/846,940

(22) Filed: Apr. 30, 2001

(51) Int. Cl. G06F 17/60

(52) U.S. Cl. 705/1; 705/400

(57) ABSTRACT

A method, system and apparatus for estimating automobile damage susceptible of paintless dent repair (P.D.R.). The method includes characterizing damage susceptible of P.D.R. by inspection of the vehicle; communicating those characterizations to a central computer, processing the characterizations based on predetermined rules stored in the central computer, and generating a report including a estimation of repair costs for the vehicle. The communication can be over a global computer network, a WAN, a LAN, or other ways to communicate between remote and central devices. A template can be used to assist in the characterization of damage.

### BACKGROUND OF THE INVENTION

1. Field of the Invention

This invention relates to a system whereby information about damage to automobiles or motor vehicles (e.g. dents) is obtained by a worker and communicated in a form that is used by software to estimate cost of repairs for that vehicle, and in particular, relates primarily to damage of the type that is fixable by paintless dent repair.

2. Problems in the Art

Presently, workers such as insurance adjusters or body repair persons, use their experience as well as some published or proprietary data to estimate body repairs for vehicles. They are supposed to examine each instance of body damage and accumulate total estimated repair costs for all of the damage.

This tends to be time consuming, cumbersome, and result in inconsistent estimates. For example, lack of attention on or to sections of the vehicle results in missed damage and thus underestimation. Lack of experience or training results in either over or under estimation of repair costs. Even trained personnel many times must refer to reference books or commercially available databases, which provide some guidance as to estimation of damage to certain parts for certain vehicles. This is time consuming and many times is costly because of licensing fees or payments required for purchase of reference materials. Sometimes those reference materials are not up-to-date.

Undoubtedly, inconsistency of estimations occurs. A worker has considerable discretion with respect to his/her characterization of damage and what it might take to repair it. Five persons, even of substantial experience and skill in the area, might come up with five substantially different estimations.

Insurance plays a significant part in the auto repair business. Insurance companies are always looking for ways to increase the cost effectiveness of coverage. For example, insurance companies have attempted to use non-OEM replacement parts, including automobile body parts, to attempt to reduce costs. Insurance companies have also looked at reducing labor costs. One example would be use of a drive-up insurance adjuster location, where the policyholder brings the car to the insurance adjuster, rather than the adjuster traveling around to policyholder locations.

Additionally, insurance companies may make deals with certain body shops. In return for referring work to the body shops, the body shops give discounts.

The point is that insurance companies look for any way to economize their liability. This includes searching for to decrease the cost of verifying damage to covered automobiles and repairing the damage.

As discussed previously, conventionally all automobile body repair is directed to automobile body shops. The body shops would give an estimate for repair. The car owner would either pay for it himself herself, or give the estimate to his/her insurance company for payment or reimbursement.

In either case, reliance is placed on the body shop both to give a reasonable estimate and to do only the amount and type of work reasonable necessary to “fix” the damage. Conventional body work usually involves using putty, sanding, and painting the affected area(s). Estimates of labor and materials are based on experience, reference materials, and/or subjective guess. In any event, the entire process is from the perspective of conventional auto body repair, which necessarily will usually involve both the labor and materials to physically alter the body and than reconstruct it.

Attempts have been made to provide industry-wide resources, such as subscriber-based publications, which list makes and models of cars and the parts, labor, and materials generally needed to fix certain areas of each car. Body shop personnel, insurance adjusters, or other estimators can subscribe and look up information from these resources when creating repair cost estimations. While this might be helpful to the process, it has deficiencies. It again is built the foundation of conventional body work. It tries to fit all types of damage into one set of estimations. It is cumbersome to have to refer to such publications and then complete the estimation. Although such systems promote more uniformity, at least for all those that rely on the same publication, the publications lag behind such things as introduction of new models or production changes, at least until the publisher has the chance to update and publish a new version.

Some newer attempts have been to publish this information in media such as CD-ROM. While this may be cheaper form of publication and allows access to the information on computers, it still requires a worker to collect information about the damage by inspection of a vehicle, and then go to a computer and look up the relevant information. Then, there must be the next step of calculating the estimate and preparing some type of report. Also, there is still a lag time between published CD-ROMs.

Software has been developed to take information from the above-mentioned publications and attempt to import it into an application that can create a report with a complete estimate. Although this is moving towards more automated estimations, it relies on the periodically published information and, again, is from the viewpoint of conventional auto body repair.

Relatively recently, an alternative body repair technique called paintless dent repair or P.D.R. has been developed. While it is not applicable to all body damage, in particular substantial damage such as created in collisions, it is proving to be effective for minor body damage. Examples would be dents, dings or other small deformations in the body where the paint remains substantially intact. One specific example is hail damage, which tends to create a substantially symmetrical, relatively small indentation in the body.

P.D.R. is based on the principal of manipulating the body back to original position, usually by pushing from the opposite side of the body. It does not generally involve any sanding, putty or painting. It does not involve drilling any small hole in the body and pulling the body material out.

P.D.R. can be much cheaper than conventional body repair and provide satisfactory results. If the repair is susceptible of P.D.R., it can be done more quickly. It can be done wherever the car is and does not require a special garage or substantial equipment, such as power sanders, paint booths, paint equipment, and the like used in conventional body shops. It does not require the substantial materials of auto body putty, paint, sandpaper, and the like.

Despite the potential efficiencies and economies of P.D.R., insurance companies hesitate to use it because of questions about reliability and consistency of estimation of cost of P.D.R. repair. Present P.D.R. workers base estimations on their own experience and subjective opinion. Estimates for similar damage vary widely from estimator to estimator. Lack of confidence by the P.D.R. estimators themselves tends to lead to over-estimations.

There is a need in the art for less inconsistency and more uniformity in estimations, less time consuming and cumbersome repair estimation, as well as easier, quicker, and less expensive methodology, including training.

### OBJECTS, FEATURES, OR ADVANTAGES OF THE INVENTION

It is therefore a principle object, feature, or advantage of the present invention to present methods apparatus, and systems for automobile repair estimation which improves over or solves the problems and deficiencies in the art.

Further objects, features, or advantages of the present invention include methods, apparatus, and systems as above-described which: (a) provide more reliability in estimations; (b) provide more consistency in estimations; (c) provide more accuracy in estimations; (d) increase efficiency; (e) are more economical; (f) can be advantageously applied to P.D.R.; (g) is easier to obtain estimations; (h) can be almost universally applied; (i) reduces the amount of tools and cost of obtaining good estimates; (j) lends itself to standardization industry-wide; (k) will promote reduction of costs to insurance companies and consumers; (l) provides the ability to keep information up to date; (m) allows easy storage of information for record keeping and other uses; (n) alerts a user, or automatically functions, to provide warnings or informational notices that may affect the estimate or to maintain adherence to predetermined rules; (o) can include fail safes to deter erroneous estimates and promote consistent estimates; (p) reduces the amount of training while maintaining or increasing consistency of estimates.

These and other objects, features, and advantages of the present invention will become more apparent with further reference to the specification and claims herein.

### SUMMARY OF THE INVENTION

The present invention relates to methods, apparatus, and systems for estimating the cost of repair of damage to automobiles susceptible of repair by P.D.R. One method includes gathering information related to damage by inspection of the vehicle. The information is entered in a form that can be digitally communicated via a network, including a wide area or global network to a central computer. The central computer processes the information and generates an estimate based on that information.

Another method utilizes a protocol for examining a vehicle. The protocol includes identifying the largest and smallest dent within a predetermined range of dents. The largest cluster of dents is identified and the number of dents within a predetermined area are counted. This information is used to estimate the total damage to the automobile, and to calculate a total repair estimation.

Another method utilizes the protocol of identifying all dents dent by dent. Each dent can be characterized, for example by size and/or severity, including whether or not each dent falls within a predetermined range of sizes or other characterization of dents. This information is used to estimate the total damage to the automobile, and to calculate a total repair estimation.

Another method allows selection between a plurality of protocols. One example is between the protocols mentioned above. Fail safes and automatic notices can be used to prevent errors and promote more objective standards of estimation.

Another method includes the use of a database having a variety of information about different models and makes of cars, including susceptibility of repair by P.D.R. on a location by location basis for the different makes and models. A requested estimate of cost of repair would automatically include a notification if a location of damage is not repairable by P.D.R. Optionally, a conventional auto body repair estimate for that damage could be given, or a notification that alternative methods must be used other than P.D.R.

An apparatus according to the invention can include a template for use in gathering information about a vehicle. The template can include openings to assist a user in identifying whether a dent falls within a range of sizes susceptible of P.D.R. It could also assist in categorizing a dent to one of a plurality of size categories within the range. It furthermore could assist a user in identifying a cluster of dents and counting the number of dents within a cluster. In one form, the template would comprise a hand-carriable member with openings corresponding to the above-described functions.

Further apparatus according to the invention could include a remote computer or data entry device, a central computer, and a communication link therebetween. The communication link could be any way to communicate data between the remote and central computer, including via a wide area or global network, whether wired, wireless, or partially both. The remote computer includes a user interface to input information related to damage on an automobile. The central computer includes software that receives and processes the information from the remote computer, and generates an estimate based on that processing.

The system according to the invention can include one or more central computers and one or more remote computers. A remote computer includes a user interface which guides a user as to appropriate information about damage to an automobile to enter. The remote computer can be instructed to communicate entered information via a communications link to a central computer. The central computer has software to process the information from the remote computer by reference to one or more databases and generate a repair estimate. The repair estimate can be communicated back to the remote computer, or otherwise communicated to one or more entities and/or stored for further use.

Another form of the system can interface with an insurance company and provide information regarding a certain vehicle, its owner, the damage, and an estimate to the insurance company. The insurance company can instigate steps in response to the estimate, such as authorizing payment, while also automatically updating its internal records.

Another form of the system involves using databases that have special information about different models and makes of automobiles, including any areas or parts that are not susceptible to repair by P.D.R. The database can also contain information regarding other parts or procedures that might be necessary to at least consider when fixing a certain damaged location of an automobile. The database(s) can be updated continuously so that that information is very up to date for all users.

### BRIEF DESCRIPTION OF THE DRAWINGS

FIG. 1A is a depiction of a vehicle being damaged by hail.

FIG. 1B is a diagrammatic view illustrating one embodiment of a system for repair estimation according to the invention.

FIG. 2 is a flow chart of steps according to a method of the present invention.

FIG. 3 is a top plan view of an information sheet that can be used by a worker practicing a method according to the present invention.

FIG. 4 is a top plan view of a template that can be used by a worker practicing a method according to the present invention.

FIG. 5 is a top plan view of a hard copy work sheet that can be used by a worker practicing a method according to one mode of the present invention.

FIG. 6 is a top plan view of a hard copy work sheet that can be used by a worker practicing a method according to another mode of the present invention.

FIG. 7 is an alternative worksheet that integrates the worksheets of FIGS. 5 and 6 together.

FIG. 8 is a diagram of a database structure for an estimation database related to evaluation of an automobile as illustrated diagrammatically in FIG. 2.

FIGS. 9A-D is a diagram illustrating more detail about the database structure of FIG. 8.

FIG. 10 is a screen shot of a web site introduction page for a web site according to an embodiment of the present invention.

FIG. 11 is a screen shot of a hypothetical example of a web site estimation inventory page for the web site of FIG. 10.

FIG. 12 is a screen shot or web site screen display for the web site of FIG. 10 for entering customer and estimate information similar to that shown at the upper part of the hard copy work sheets of FIGS. 5 and 6.

FIG. 13 is a screen shot of a web site “current vehicle selection” page hypothetical example for the web site of FIG. 10.

FIG. 14 is a screen shot of a web site “vehicle inventory” page hypothetical example for the web site of FIG. 10.

FIG. 15 is a screen shot of a web site “vehicle and estimation details” page hypothetical example for the web site of FIG. 10.

FIGS. 16A and B are a screen shot or web site screen display which is essentially an electronic version of the hard copy work sheet of FIG. 6.

FIG. 17 is a screen shot of a P.D.R. estimation report after calculation of data related to the information derived from a Manual Count evaluation of a vehicle in a hypothetical example.

FIGS. 18A and B are a web site screen display which is essentially an electronic version of the hard copy work sheet of FIG. 5.

FIG. 19 is a screen shot of a P.D.R. estimation report after calculation of data related to the information derived from a Easy Count evaluation of a vehicle in a hypothetical example.

FIG. 20 is a screen shot of a parts list for a selected vehicle, including cost and labor.

FIG. 21 is a screen shot of a display to assist an estimator in making P.D.R. estimations.

### DETAILED DESCRIPTION OF EXEMPLARY EMBODIMENTS

A. Overview

To better understand the invention, specific exemplary embodiments will now be described. Frequent reference will be taken to the accompanying drawings. Reference numbers will sometimes be used to indicate certain parts or locations in the drawings. The same reference numerals will indicate the same or similar parts or locations throughout the drawings, unless otherwise indicated.

B. General Environment

The exemplary embodiments will be described in the environment of what is called paintless dent repair (P.D.R.) estimations.

P.D.R. refers to dents that are usually repairable without painting. Examples are dings, pings, or hail dents, if within a certain range of sizes. By “pointless” it is meant that the dent is pushed out from the inside to the original contour of the body work, and traditional body work and painting is not normally required; thus the name “Paintless Dent Repair”. Sometimes minor touch up paint is used.

C. Apparatus and Hardware

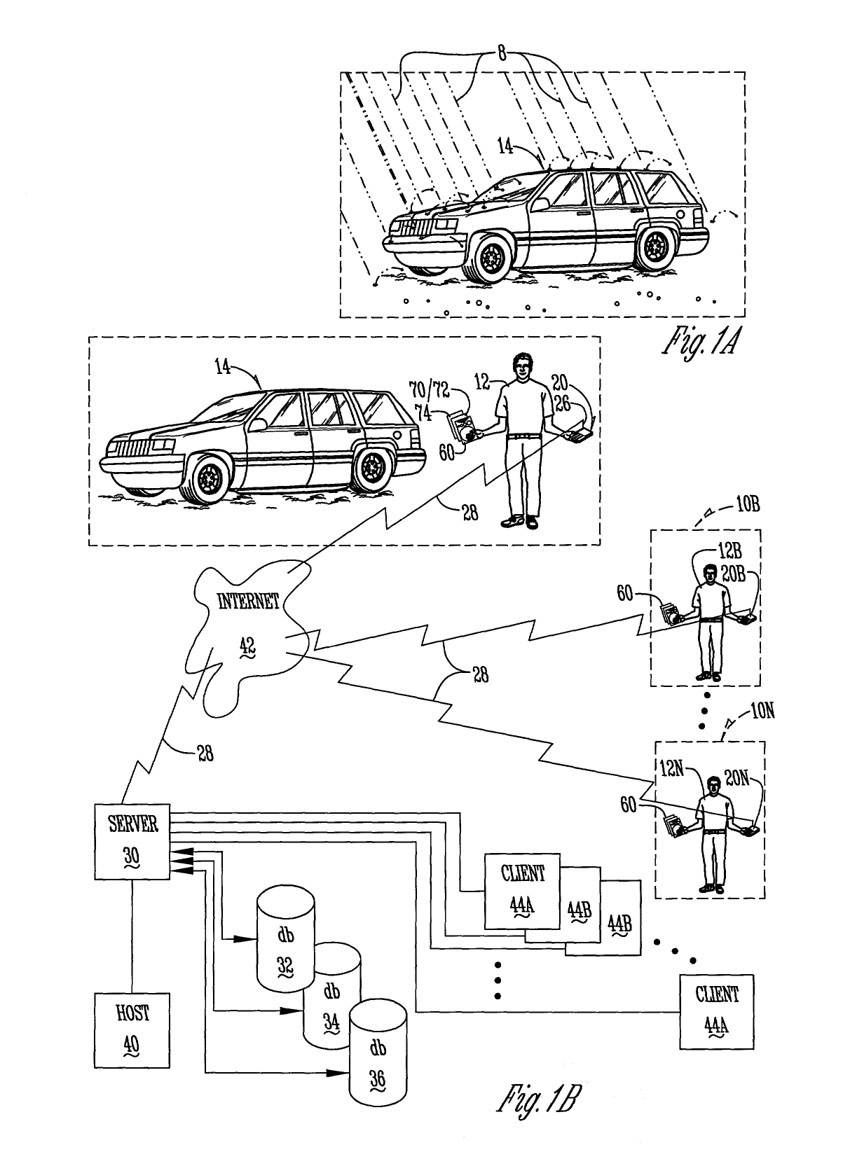

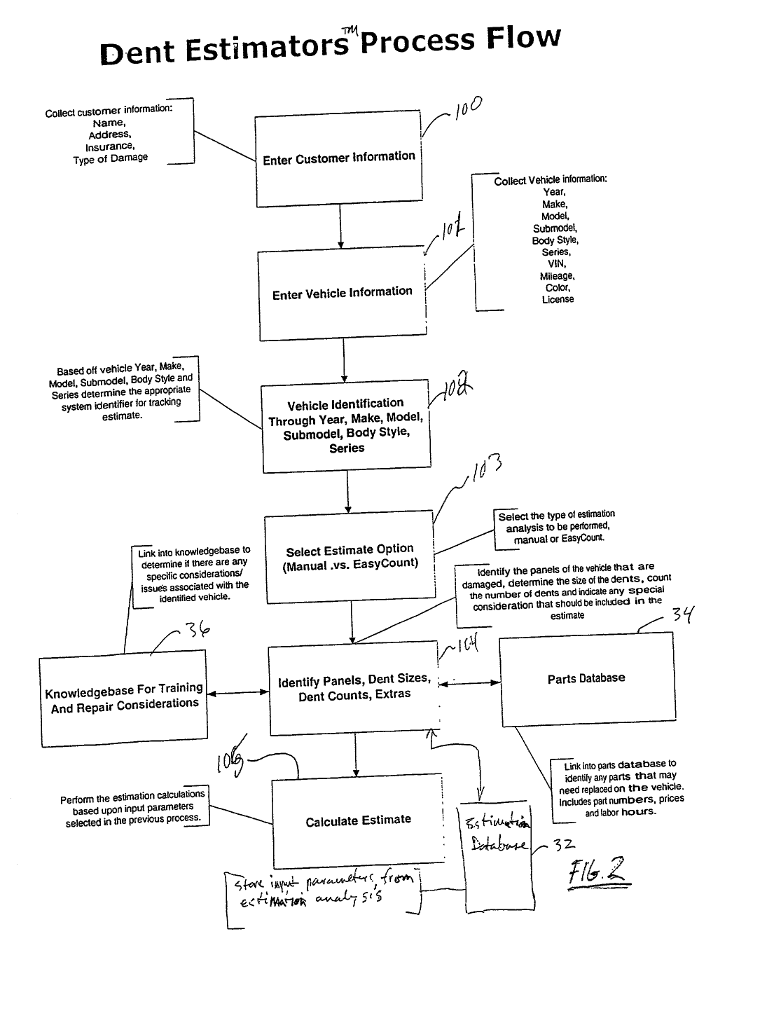

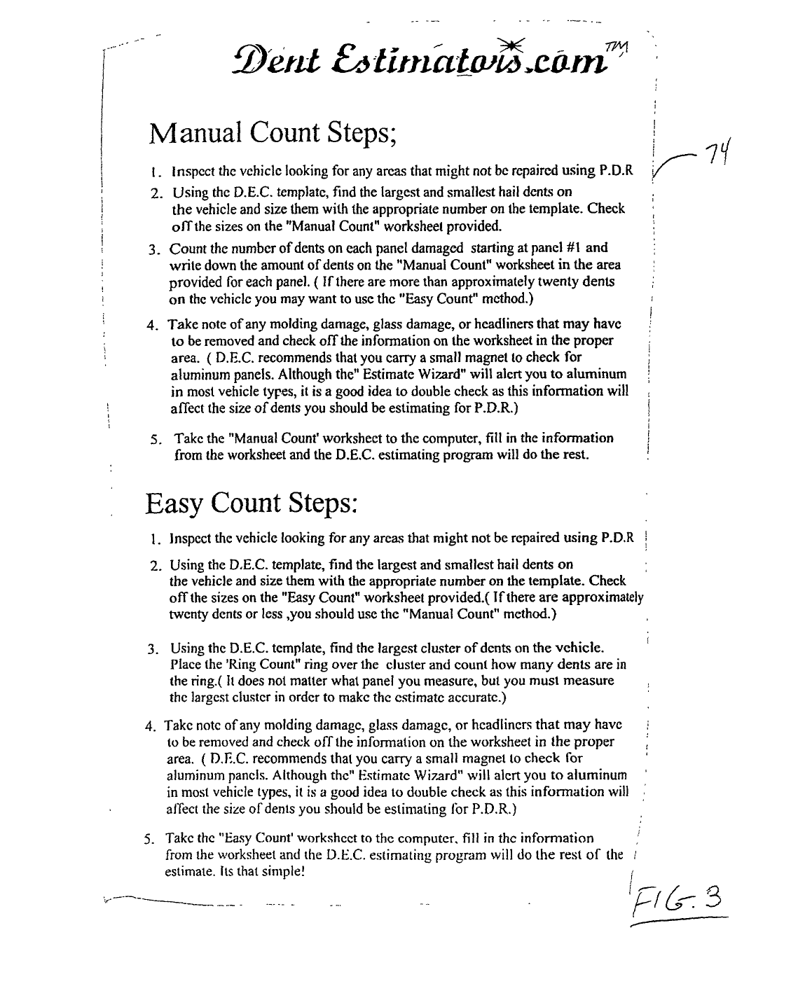

FIG. 1A show and example of the type of vehicle damage that can be susceptible to P.D.R. Hail 8 usually strikes most prominently on the hood, roof, and trunk. Damage can involve multiple relatively small dents. Sometimes the hail only damages one part of the car, e.g. hoods are frequently more susceptible. Traditional body shop estimations would estimate either cost of sanding, putty, pull out of dents, priming and re-painting, or replacement of the panel.

FIG. 1B illustrates one embodiment of apparatus and hardware used in a system for obtaining P.D.R. estimations according to the present invention. A worker 12 has access to a damaged automobile 14 at what will be called an estimation site 10. Site 10 can be a designated location to bring cars to for evaluation (i.e. the car 14 is brought to worker 12) or could be the location of the car (worker 12 goes to car 14). A computer 20, locally accessible by worker 12, is connected to the Internet by any of a number of ways currently available. Computer 20 has a user interface including a display 22 and a user input 24 (e.g. keyboard, touch screen, mouse, etc.).

A remote or central computer, here server 30, is connected to the Internet 42. Server 30 also has access to one or more databases 32, 34 and 36. Server 30 can also be connected by Internet 42 or otherwise to what will be called a host computer 40. Host computer 40 could be a computer at an entity controlling server 30 or some other entity or computer.

Computer 20 has a radio frequency transceiver/antenna 26 and is connectable to server 30 via radio waves 28; in this example via a widely distributed network, here a global computer network, e.g. the Internet, by wireless technology, such as is known. Communication could also be via a propriety wide-area network (WAN), or local area network (LAN), or some other method.

As illustrated in FIG. 1B, the system can be configured to service a plurality of distributed computers 20 at a plurality of distributed estimation locations (see reference numerals 10, 10B, . . . , 10N and 20, 20B, . . . , 20N). Computers 20 could be close together or widely distributed, across a region, a country, or globally.

Also, server 30 can be connected to a plurality of what will be called clients 44. For example, clients 44A, 44B, . . . , 44N can be different insurance companies or branches of the same insurance companies. Clients 44 could be widely distributed, even globally.

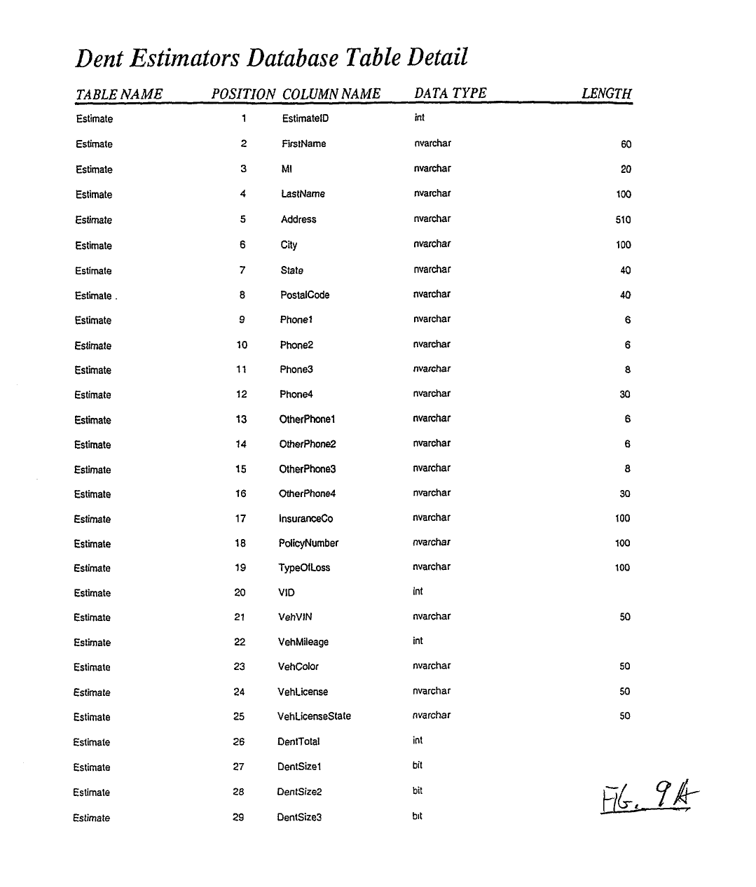

Thus, the system can service multiple estimation sites 10 and provides a communication link between those multiple sites and a central processor, e.g. server 30. 63. According to one embodiment of the method, a physical template 60 and record sheet(s) 70 and 72, and/or an instruction sheet 74, can be carried by worker 12 to damaged automobile 14 at estimation site 10. Template 60 (see FIG. 6) has a series of different sized holes 62, 63, 64, 65 that define the general range 67 of dents repairable by P.D.R. Template 60 is easily manipulatable to position it on or adjacent different parts of car 14 and dents can be viewed through openings 62-65. Template 60 also can include a much larger opening 66 that is used to circumscribe concentrations of dents which is then used in a manner discussed later.

D. Software

Server 30 can run Microsoft Windows NT 4.0 and perhaps Microsoft Windows 2000. It would generate and control access by remote computer 20 and clients 44, and the screen displays available to those entities. It would also operate on input from those entities.

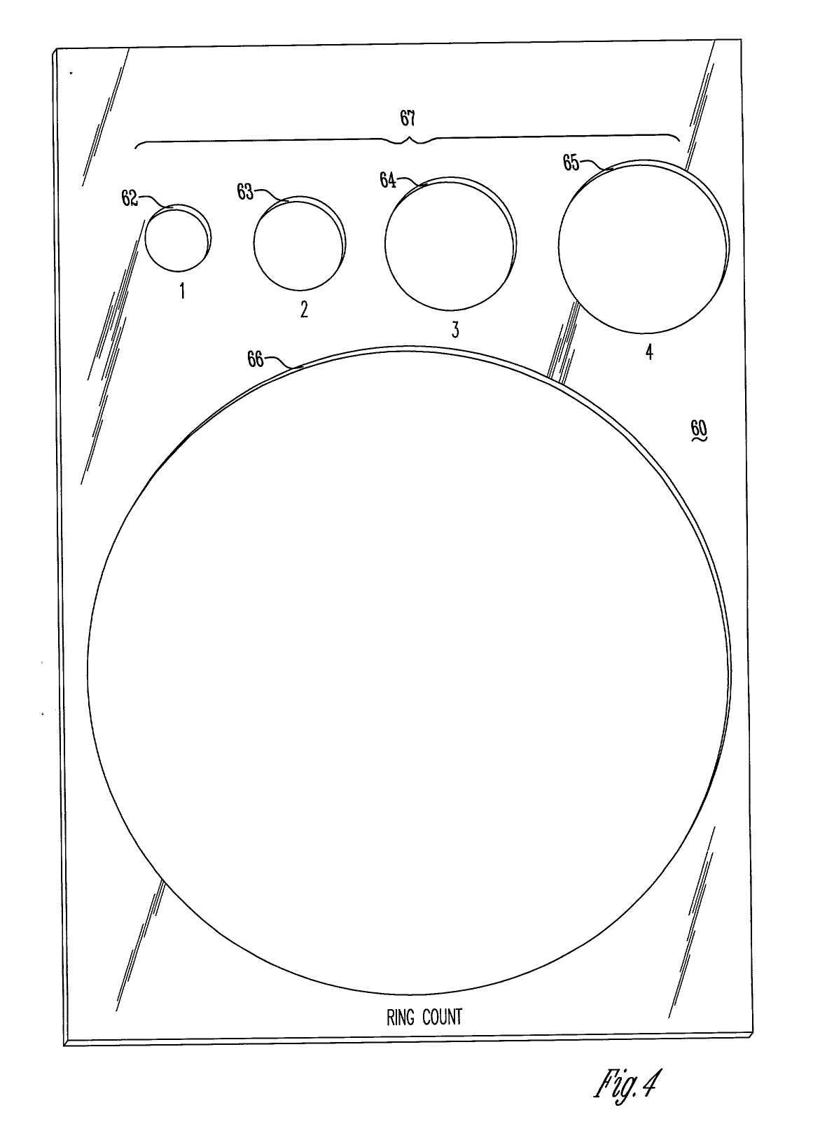

FIG. 2 is a flow chart of the general functionality of application software for server 30. Software for the estimation calculations according the embodiment of the invention is written in Microsoft Visual Basic 6.0 SP3. The interface to the software is developed and implemented through Microsoft IIS 4.0 running under Microsoft Windows NT 4.0. FIG. 2 gives an overview of how the software programming works, and will be discussed in more detail later.

E. Communications

Communication software can be of any type that allows interactive communication of remote processors with a server via a global or worldwide computer network such as the Internet. An example is Microsoft IIS Internet Information Server with a browser client based software; e.g. Microsoft Explorer 4.0 or Netscape 4.0.

A website is created, and in this embodiment, is accessible by authorized password protection by authorized persons (e.g. workers 12) and subscribers (e.g. clients 44). The website can have many modules, including a training module to assist workers in effectively practicing the methodology. The website also includes data entry form(s).

F. Database(s)

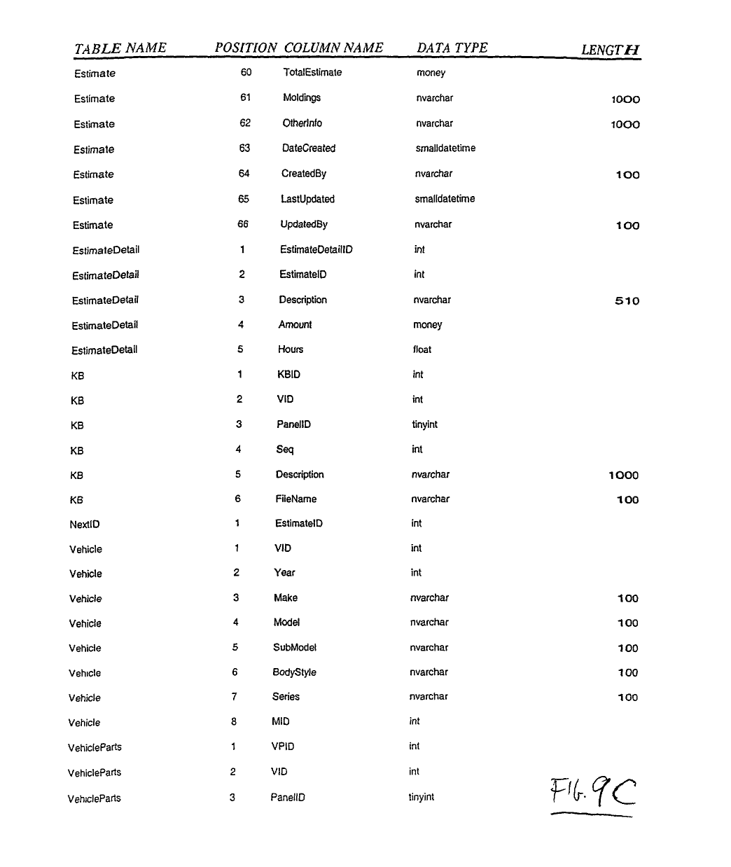

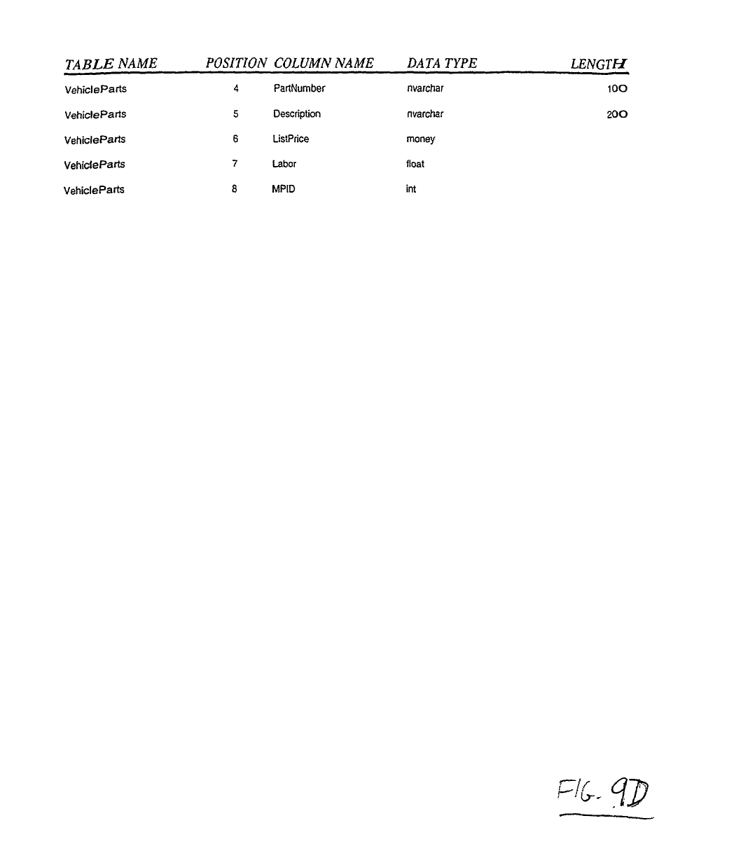

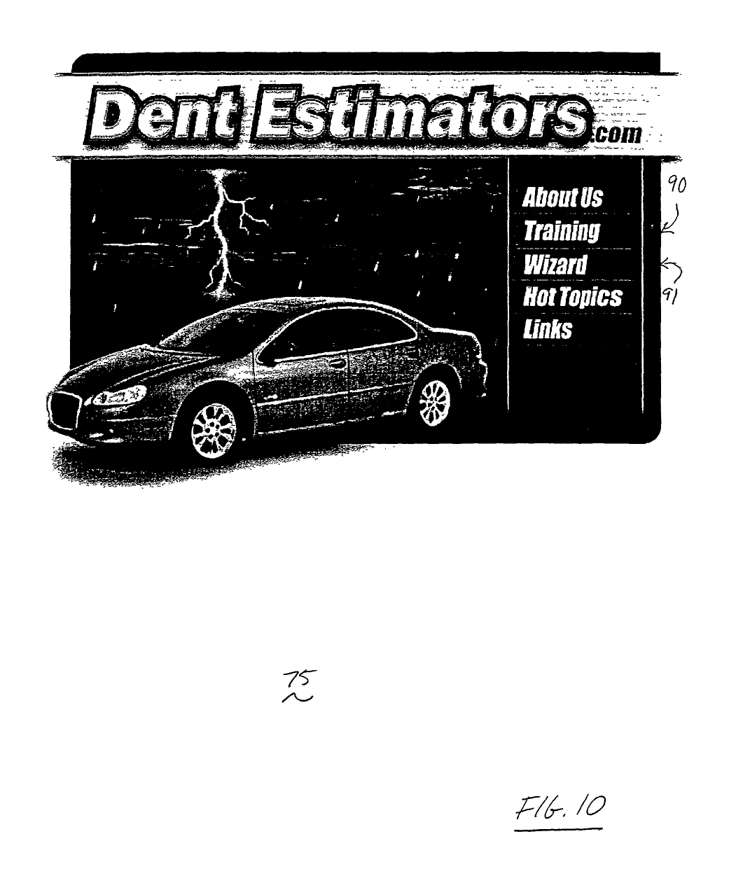

The data base and data management functions can be realized using Microsoft SQL Server 7.0 and include one or more databases useful in P.D.R. estimations. For example, data can be collected and managed through the Dent Estimators website located at a domain name. FIGS. 10-19 provide screen shots of some of the user interfaces from the website. See FIGS. 8 and 9A-D for the database structures used.

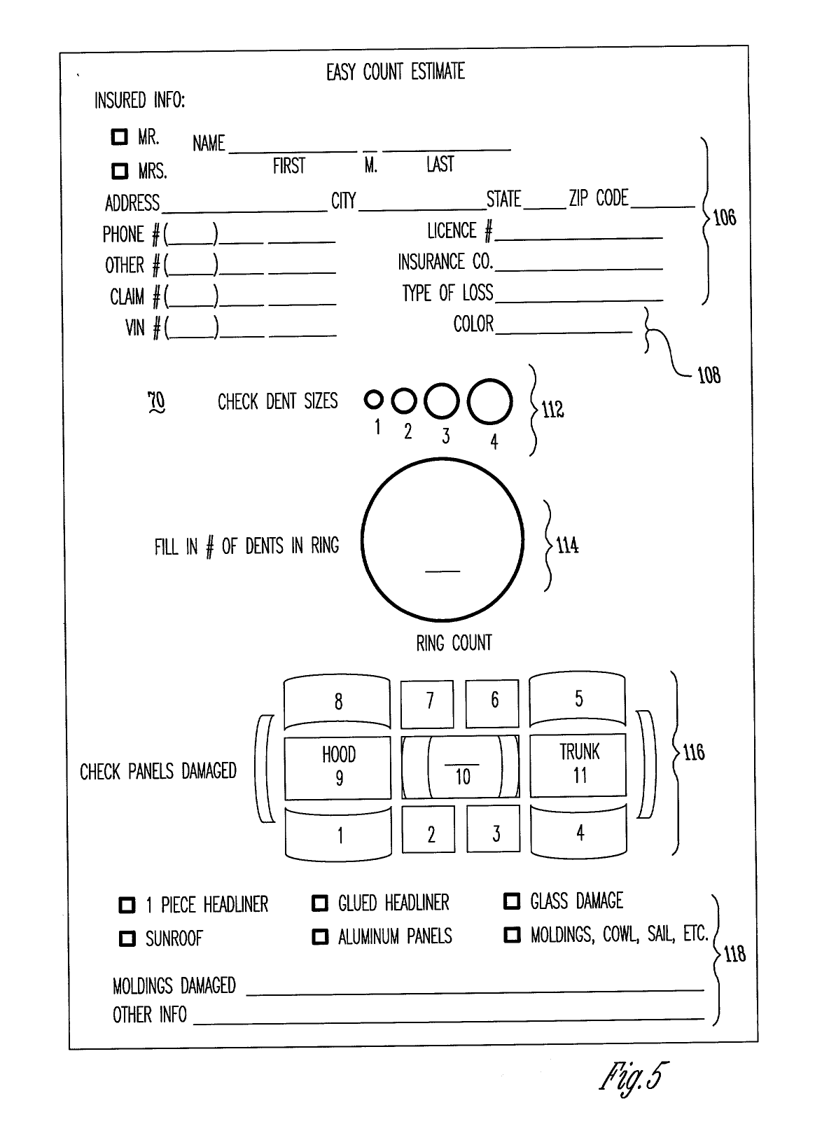

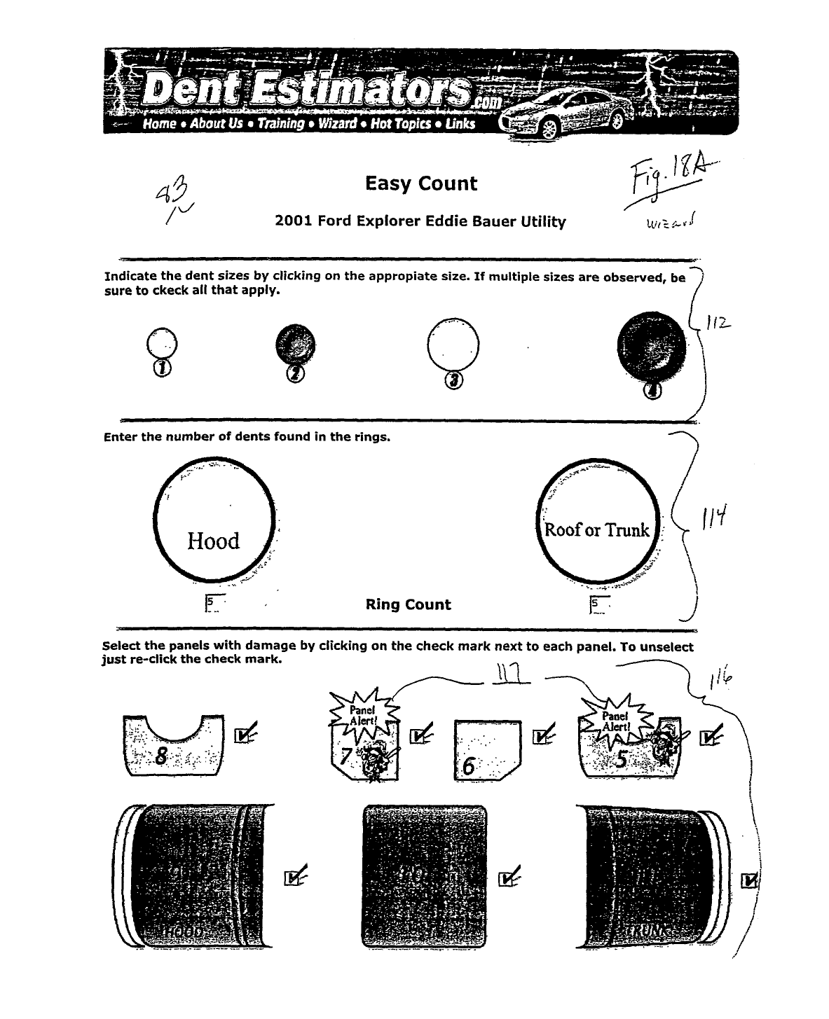

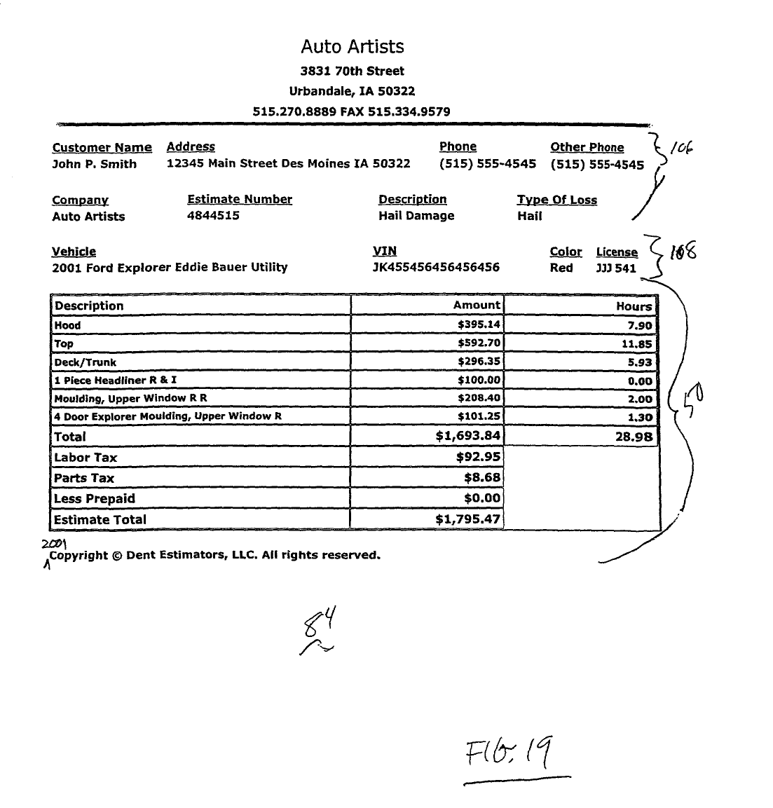

For example, a database 32 (See also FIG. 2) can store information input from a worker 12's review of a car 14, as prompted by work sheet(s) 70, 72, and/or 74 (see FIGS. 3, 5, and 6) or screen displays 75-84 (see FIGS. 10-21). Database 32 or the programming can include instructions or formulas for generating estimations based on the data input by worker 12 about a car 14. The software can also generate electronic or hard copy reports of estimations (see, e.g., FIGS. 17 and 19).

A database could include information on a variety of parts for a variety of automobile makes and models, including part numbers, price, and labor costs for replacement of a part on a vehicle. Such a database (illustrated diagrammatically at reference number 34 in FIGS. 2 and 8), can be constantly updated, such as for new cars or changes in existing cars, or the part numbers, prices or labor costs associated therewith. This information is available form parts books or other public sources.

A database could include what might be called a “knowledge base” useful in P.D.R. estimations, see reference numeral 36 is FIG. 2. The knowledge base database 36 can be created by information derived from evaluating many types of vehicles. For example, the first 2001 Ford Taurus examined for repair estimation will reveal that P.D.R. might not be able to be used for certain locations or parts of the car. A welded brace might prevent P.D.R. from being accomplished along the line of the welded brace. As new models of vehicles are introduced to the public, the knowledge base is updated. Thus, the estimations will likely have current and accurate information for most if not all vehicles. Compare this to a subscription service that sends out an updated reference book once every year.

Other information can also be added to the knowledge base. An example is if a former model and make of car changes from a steel to an aluminum hood. Because the design and make-up of automobiles changes from time to time, the knowledge base can be continuously revised and updated even for older models. Utilizing the knowledge base and database form in association with software running behind a website, means that the knowledge base is usually more up-to-date than published books or CD-ROM based products that are sent out to estimators and adjusters. It is not believed any of these existing reference sources include all the types of information included in the invention's knowledge base (e.g. replaces where P.D.R. is not applicable). This should result in better estimations from the present invention.

FIGS. 8 and 9A-D illustrate generally one form databases can take. Other forms are possible.

For example, a certain predetermined set of prices could be stored for hail damage. The prices would be based upon such things as characteristics of hail dents, normal range of sizes of hail dents, number of hail dents, and the like. On the other hand, a different set of prices could apply to door dings; dents caused by others opening doors into a car's doors. Such dents tend to be lower in number but bigger in size than hail dents. Normally, there is no cluster of dents like can happen with hail damage. Therefore, the worksheets prompt the worker to list the type of damage to the car. If hail damage, one set of pricing would be activated. If door dings, a different set of prices would be activated. Other types of damage could be programmed into the software. This is a type of fail safe or automatic control to improve accuracy and consistency of P.D.R. estimates.

G. Example of Operation

By referring to FIG. 2 and the other Figures, a more specific example of operation of the invention will be described. This hypothetical example is premised on the occurrence of a significant hail storm that has passed through a region in two adjoined states of the United States of America. Hail damage has occurred to a number of cars exposed to the hail, whether parked in the open or traveling. Examples include privately owned automobiles, cars sitting out on automobile dealer lots, and fleets of company-owned cars.

Once aware of the hail storms and potential liability, insurance companies set up one or more designated estimations sites (reference numbers 10A-N) to gather information about their insureds' car damage, and process any claims as quickly and efficiently as possible. Generally, locations 10 are set up in the area of the hailstorm (in the insurance industry sometimes called a CAT) and insureds are notified of the locations and times to get estimates done.

(1) Information Gathering

The method of the invention is practiced according to the following general steps.

A worker (the damage evaluator) 12 either goes to an established estimation location 10, where the insureds' cars are brought (e.g. a CAT location), or to the location of the car (e.g. an insured's home or business, a car lot, a business fleet lot).

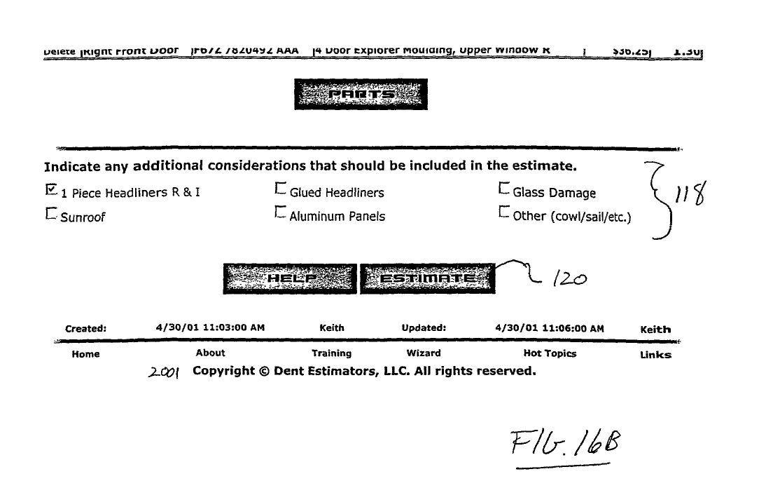

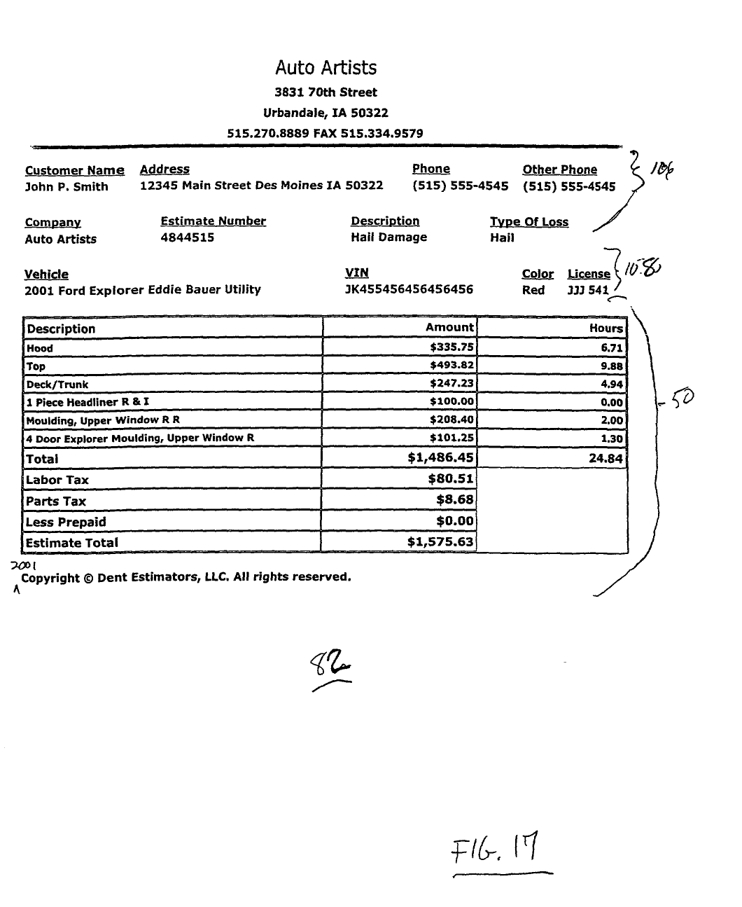

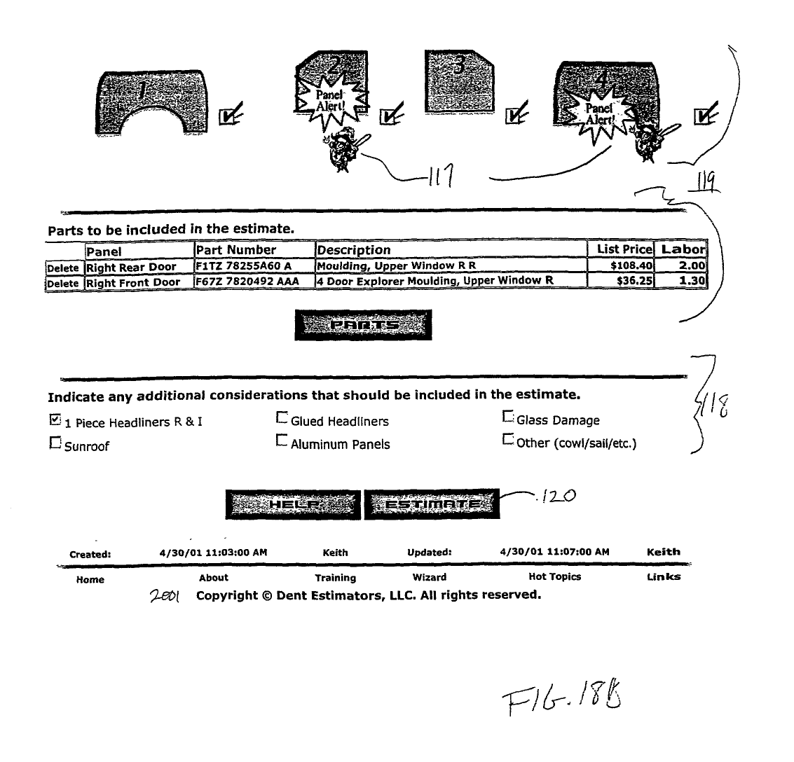

The worker 12 brings template 60, and record sheet 70 and/or 72, and/or instructions 74 (see FIGS. 3-6) to damaged automobile(s) 14 at site 10A. Alternatively, worker 12 brings template 60 and has a computer 20 available at site 10A, which has electronic versions of the instruction sheet 74 and worksheets 70 and 72 (see FIGS. 16 and 18 and help screens or training sections).

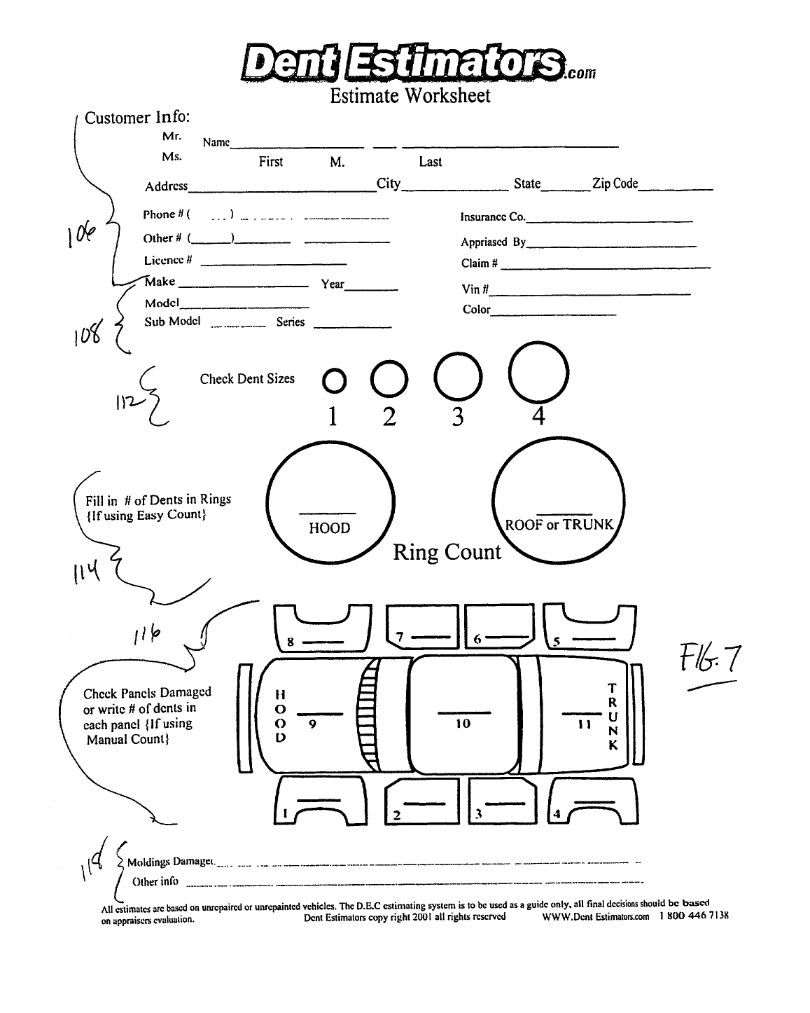

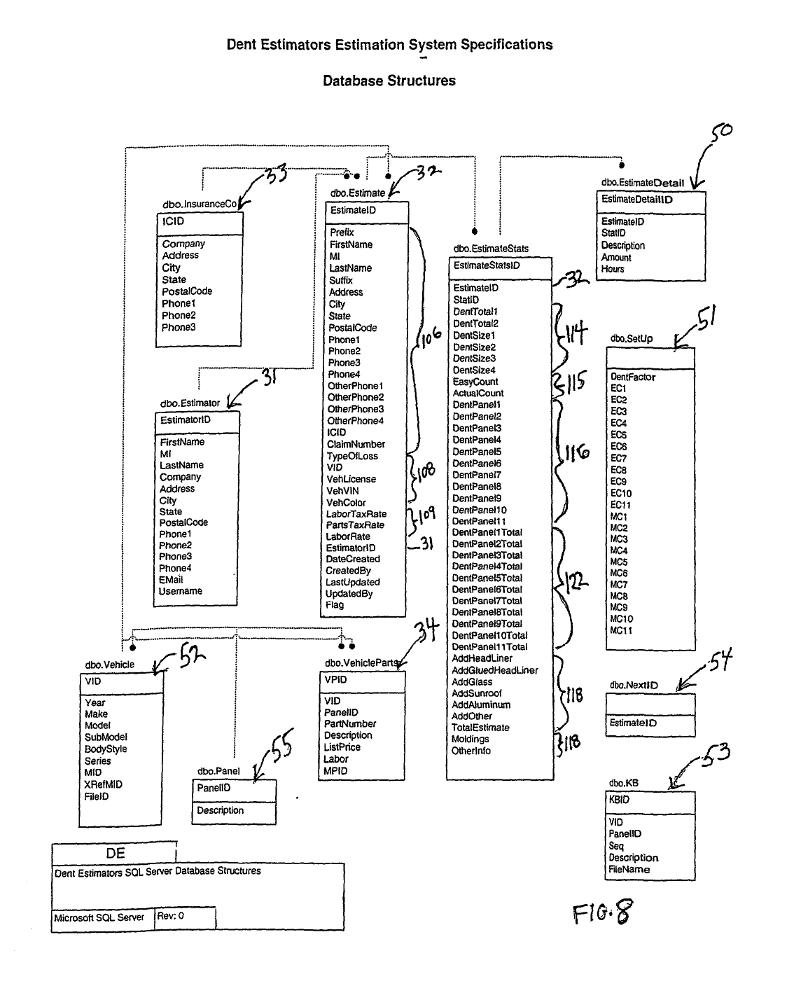

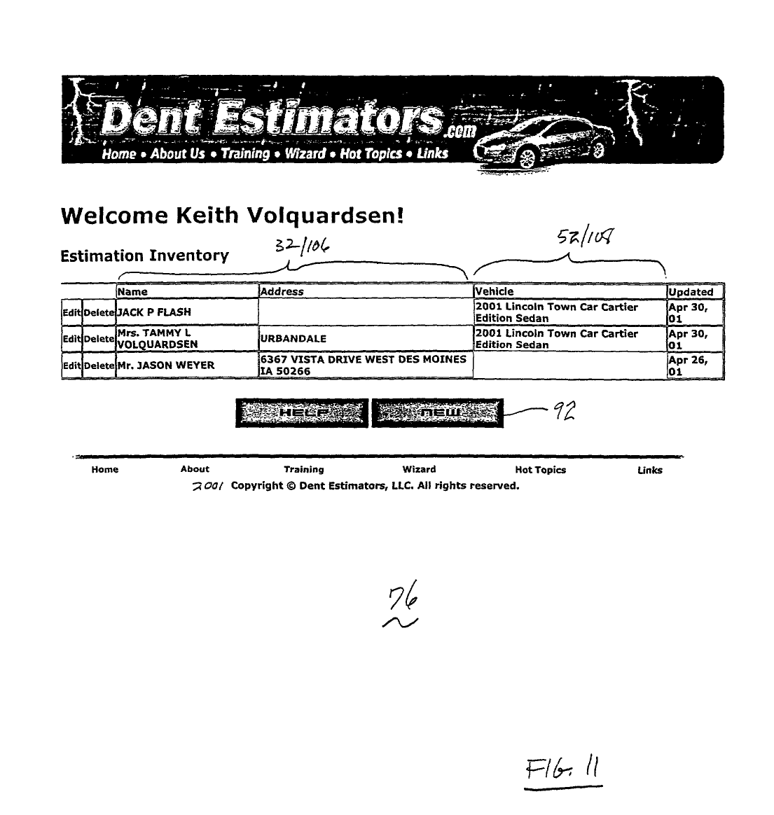

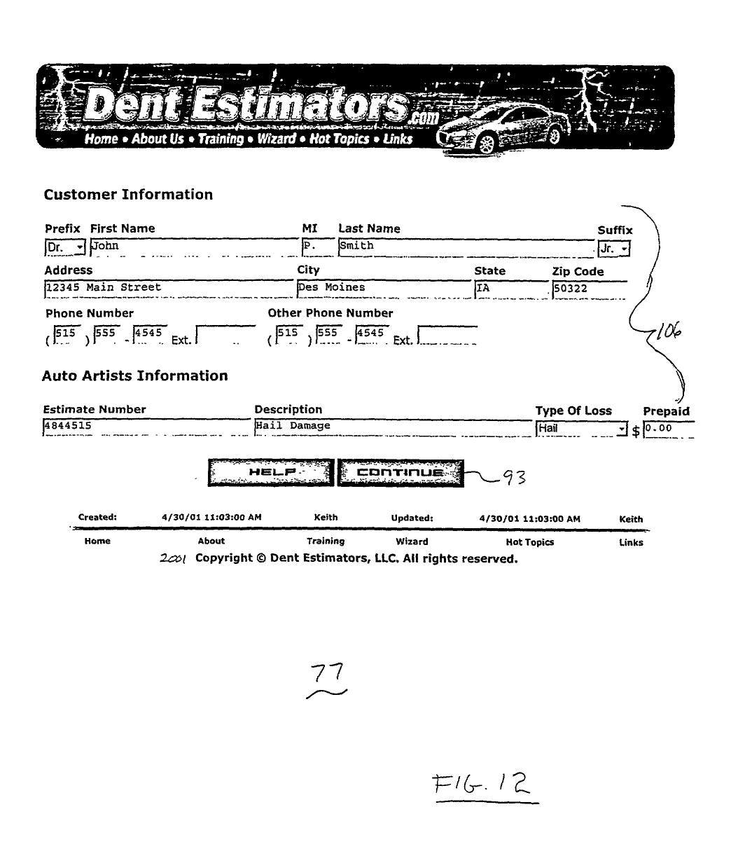

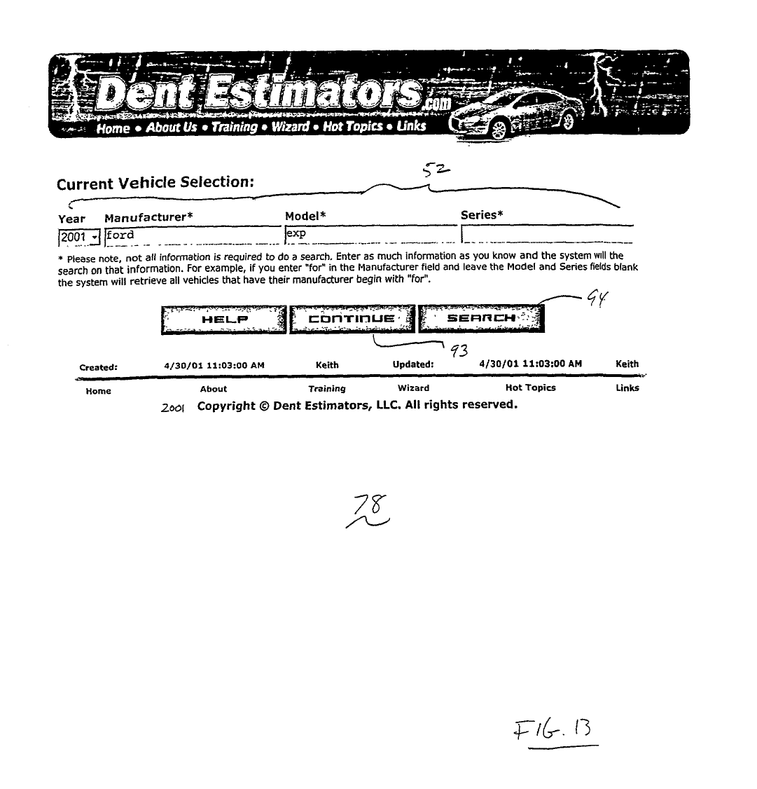

STEP 100: As prompted by the worksheets, worker 12 would enter “Customer Information” of the type indicated at FIG. 2. This is normally identifying information about the insured and general information about the damage at issue. See reference numerals 106 at FIGS. 5 and 12. Alternatively, there may an inventory of vehicles previously entered and stored (e.g., see FIG. 11—from another database). Worker 12 can simply call up the inventory and select a vehicle.

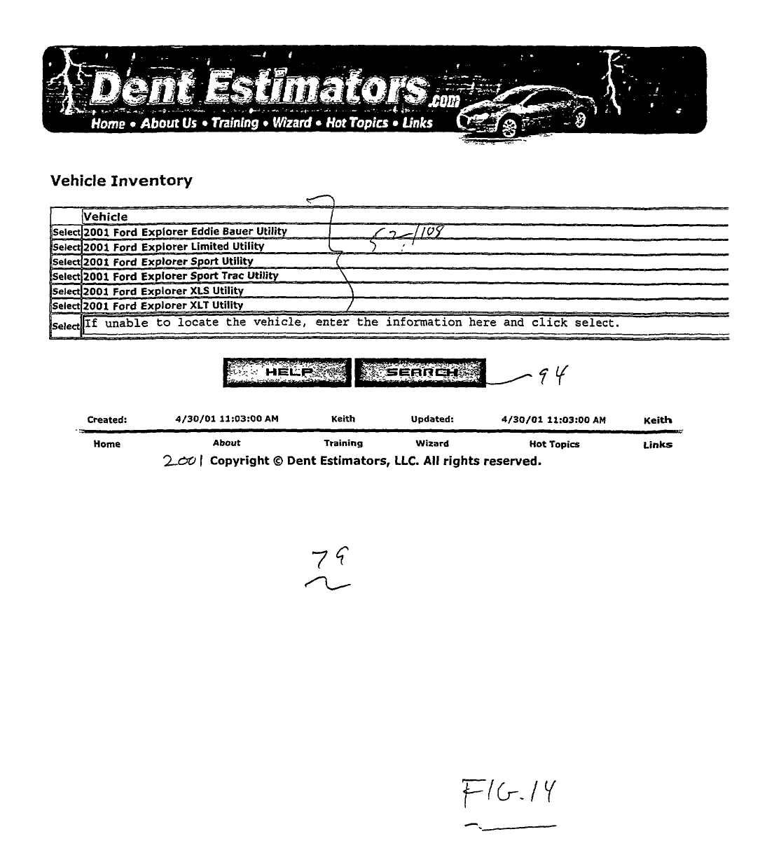

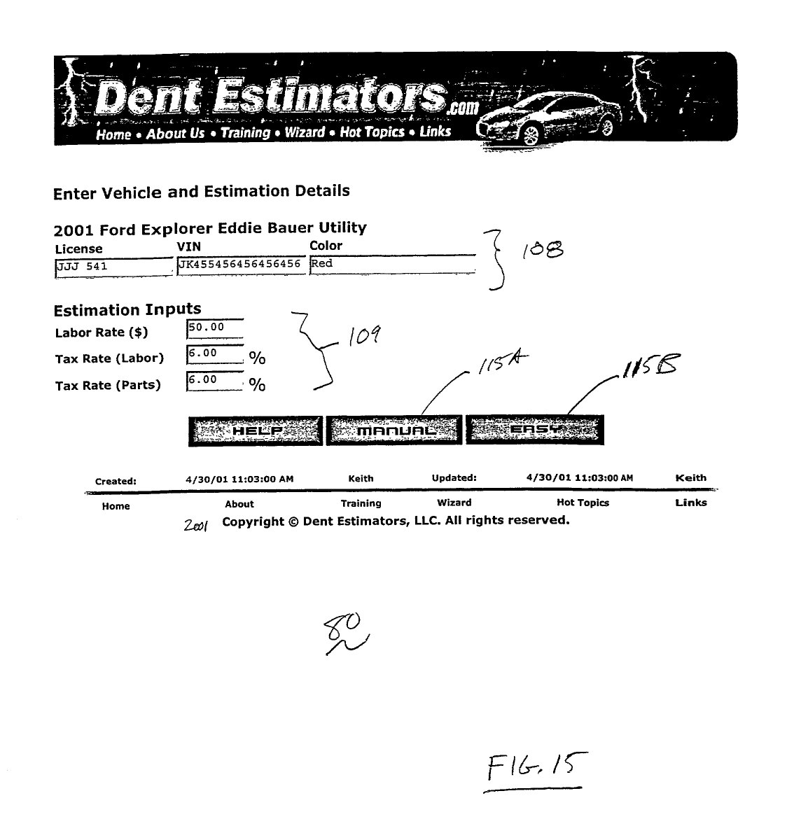

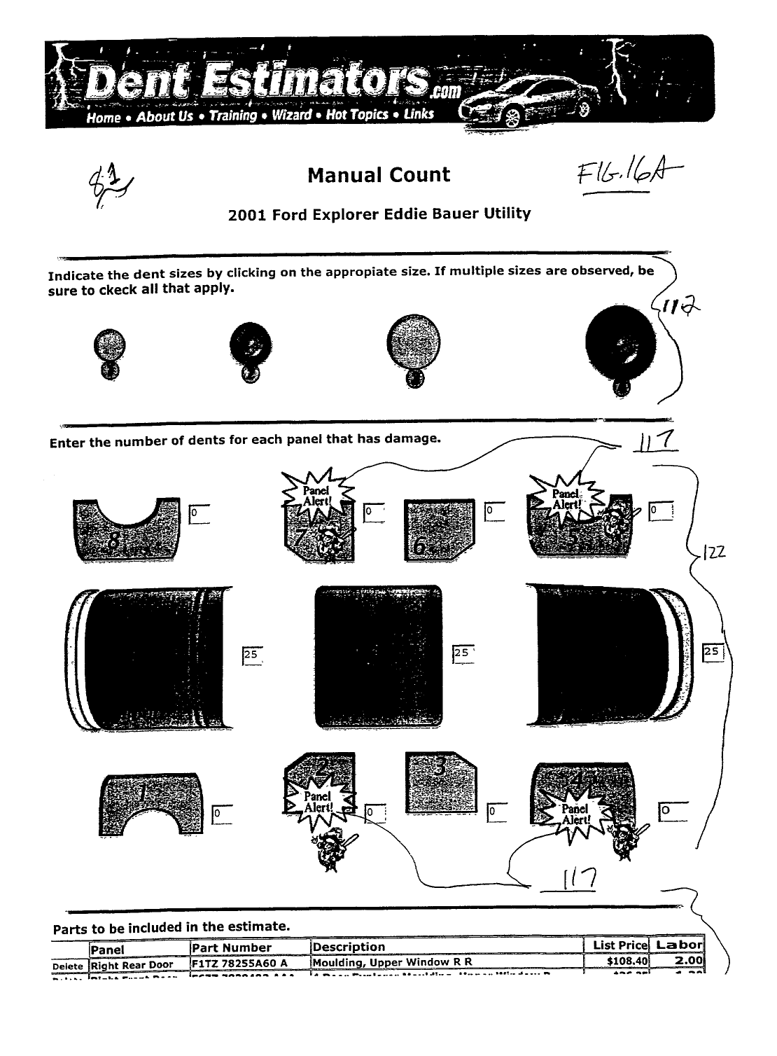

STEP 101: As prompted by the worksheets, worker 12 would enter “Vehicle Information” of the type shown in FIG. 2. See reference numerals 108 at FIGS. 5 and 15. Alternatively, one could select a vehicle from “inventory” (see FIGS. 13 and 14).

The information gathered in steps 100 and 102 is specifically shown at the top of FIGS. 5 and 6 and at FIG. 15.

STEP 102: The software would take the Vehicle Information of step 102 and create a system identifier for that vehicle 14 (see, e.g., FIG. 8, reference numbers 53 and 54). The system identifier would be a characterization of vehicle 14 that will be used by the software to correlate the type of vehicle to estimate of P.D.R. costs. Also, the user is prompted to enter local labor rate and tax rates on labor and parts (FIG. 15, ref. no. 109).

STEP 103: Two modes or protocols for P.D.R. estimation are available. Worker 12 selects which one to use. If what is called “Easy Count” mode is selected, worker 12 either selects hard copy worksheet 70 of FIG. 5 or button 115B (FIG. 15) on the screen display of the user's computer (if data is going to be directly entered electronically). The computer would then display screen 83 FIGS. 18A and B). If button 115A of FIG. 15 (manual count mode) is selected, the screen display will change to screen display 81 of FIGS. 16A and B. As can be seen, the information on both work sheet 72 and screen display 81 is very similar.

STEP 104: The instructions at the bottom half of instruction sheet 74 of FIG. 3 describe the “easy count” mode or protocol for gathering information about the damage to vehicle 14.

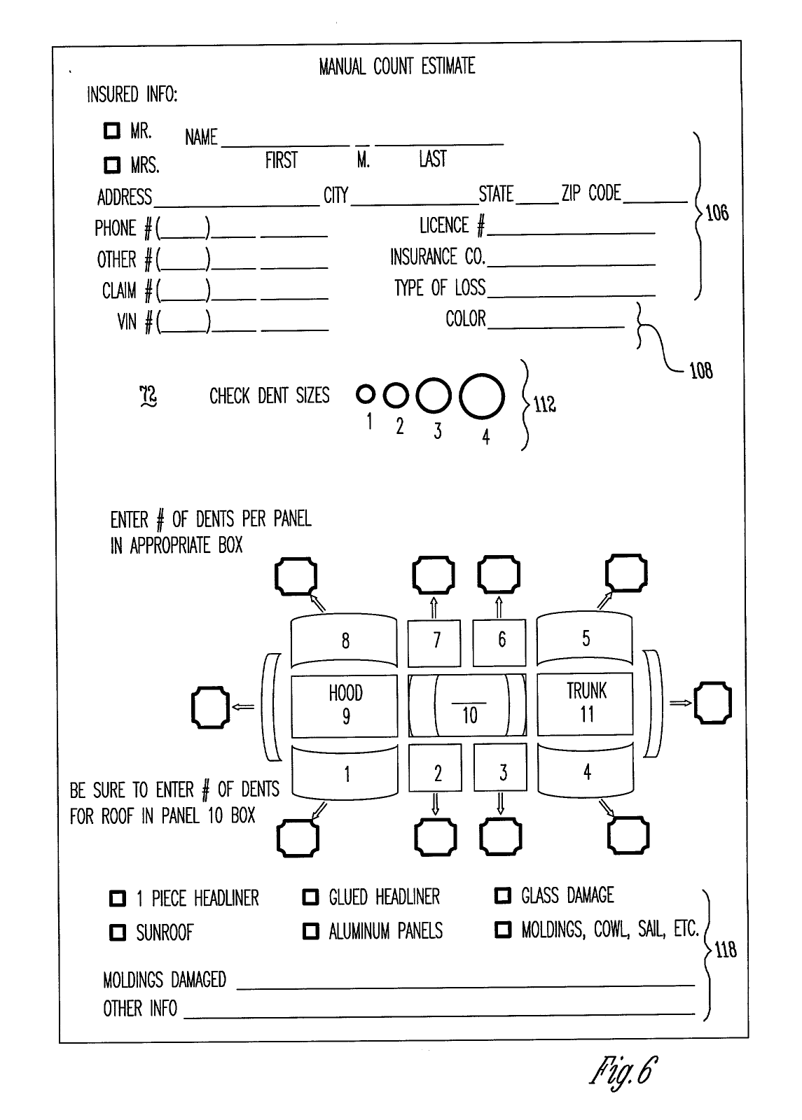

Worker 12 uses the range of different sized openings 62-65 on template 60 (see FIG. 4) to identify the smallest and largest dents on automobile 14 that fall within the range 65 of openings of template 60. In other words, the worker is finding the smallest and largest dents that fit within the smallest and largest of the openings in template 60 and records that information on record sheet 70. In one embodiment, used for hail damage, holes 62-65 have the following diameters respectively; ⅝″, ⅞″, 1¼″, and 1⅝″.

As prompted at worksheet 70 or screen 83, worker 12 merely marks or selects the opening 62-65 which circumscribes the smallest dent on car 14 within the range of opening sizes 62-65, and marks or selects the opening 62-65 which circumscribes the largest dent within the range of opening sizes 62-65 (see reference numeral 112). Thus, this is a de facto fail safe or rule to make estimates more consistent.

Worker 12 then identifies where there is the highest concentration of dents within the range of template openings 62-65 and places the much larger opening 66 (e.g. 6¼″ diameter) of template 60 around that cluster of dents and counts the number of dents in that concentrated area and records it (see reference number 114) by either writing the number on worksheet 70 or entering a number where indicated on screen 83.

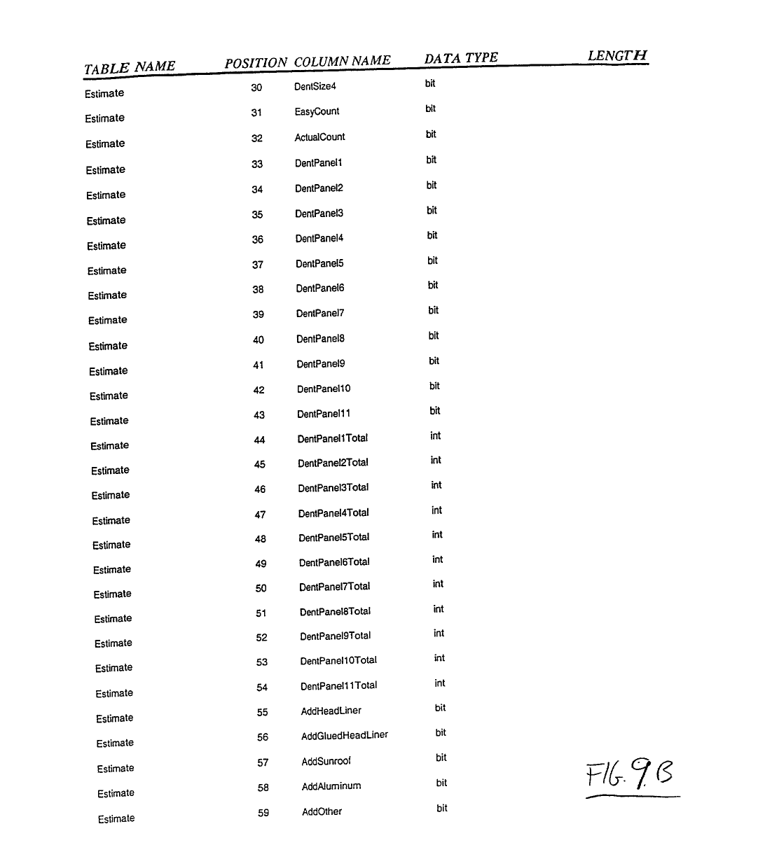

Obviously, if the information described above is recorded on worksheet 70 carried by worker 12, that information can then entered into essentially virtual electronic worksheet 83 similar to worksheet 70 (or the combined worksheet of FIG. 7) that is generated on the display of computer 20 when the worker gains access to the website. This can be done locally near the automobile 14 being investigated (either at a desktop Internet connected computer or a portable computer connected to the telephone system either by wire or wireless). It is possible even to use smaller devices such as handheld personnel data system devices (PDA's) or other devices. If the worker has a portable or hand held appliance or computer that is connectable to the Internet, the information is entered directly into electronic virtual worksheet 83.

As prompted by worksheets 70 or 83, worker 12 then records which parts of car 14 have damage of the type identified with template 60 by simply marking relevant body panels on the generic diagrammatic exploded plan view of the exterior of an automobile (see reference numbers 116 at FIGS. 5 and 18). Body panels are given number 1-11 and front and rear bumpers are included with panel numbers 9 and 11 respectively.

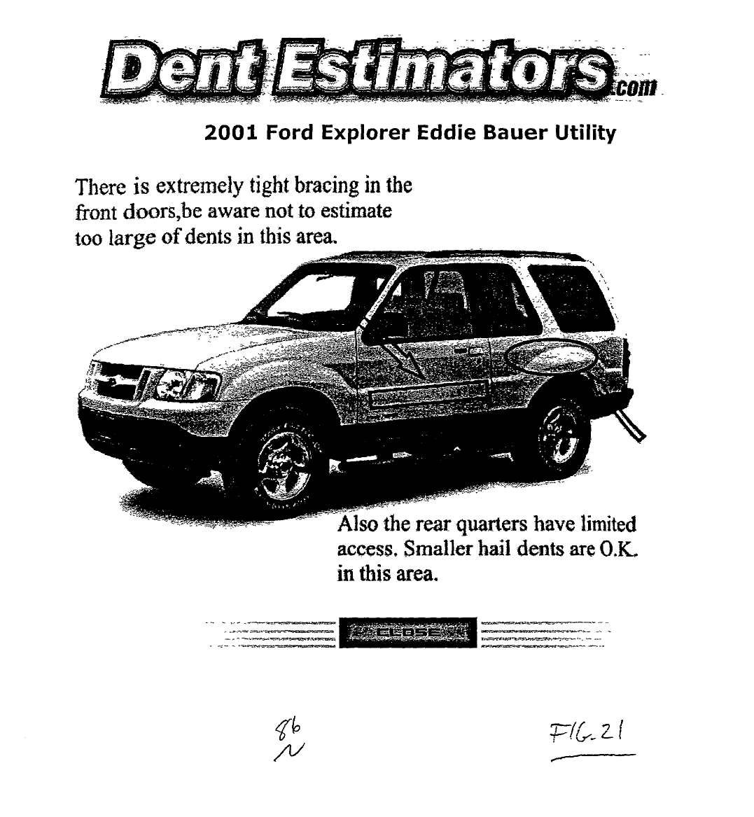

Additional damage information is also prompted by worksheets 70 and 83. As shown, damage to glass parts (e.g. windshield, windows), trim pieces (e.g. molding, cowl, sail), or even interior parts (e.g. headliner) can be recorded by marking or selecting (see reference numerals 118 in FIGS. 5 and 18. Also, other information is prompted. Examples are whether any parts are aluminum. This may require a different estimation protocol, formula, or even may result in an indication that P.D.R. is not recommended. Another example is shown at reference number 119 of FIG. 18—identification and price of replacement parts can be displayed (if selected). Also, discussed more later, FIG. 18 shows visually a “panel alert” 117 warning and icon. It may indicate, e.g., the presence of aluminum parts for the selected vehicle, location of places not susceptible of or difficult to perform P.D.R., etc. One could click on the icon to find out more about the alert. For example, a screen such as FIG. 21 might pop up, giving explicit directions and assistance to the estimator regarding problems with P.D.R. for that part or panel. This likewise is a fail safe, or automatic assistance that leads to more accurate and consistent estimations. A variety of fail safes or notifications can be generated depending on the circumstances.

Both worksheets 70 and 83 allow text to be entered regarding comments about the vehicle, the damage, or the parts, if deemed needed. Other information can be requested and entered.

FIGS. 8 and 9A-D illustrate how information from worksheets 70 and/or 83 are stored in database 32. FIG. 8 is a diagrammatic illustration of design of the structure of database 32. Information indicated at 106, 108, 114, 116, and 118 from worksheets 70 and 83 are indicated by the same reference numbers in FIG. 8. FIGS. 9A-D give more detail about the database, including indications of position of various information from FIG. 8 in the various tables of FIG. 8, e.g. column name, data type and length.

In this embodiment, the database structures can be as illustrated at FIGS. 8 and 9A-D. However, variations are of course possible. Identifying information regarding insurance companies, workers (estimators) 12, vehicles, and the estimations can be stored (see reference numbers 33, 31, 52, and 32 respectively).

The “EstimateID” table contains the gathered information from steps 100, 101, and 104 of FIG. 2 for the Easy Count mode. The identifier labeled “VID” in the EstimateID table is the identifier created by the software in step 102 of the program of FIG. 2.

Estimate DetailID table 50 (see FIG. 8) stores details about a particular estimate, including the amount and time for repairs, as well as text description of the same.

VID table 52 (see FIG. 8) illustrates the type of information stored for various makes, models and styles of cars. The VID is an assigned integer number characterizing each of the plurality of such car styles.

The “KBID” table 53 is an internal identifier for every element of the knowledge base; kind of a unique key for that information.

The “VPID” table is the parts database 34 discussed earlier, and is used if a part is identified in the inspection of a car 14 as needing replacement. Table 34 has the part number, description, list price, labor time or cost, and other information needed to include a replacement part into a repair estimation.

(2) Estimate Generation

STEP 105: Once worker 12 has either completed worksheet 70 and taken it to a computer 20 and entered the appropriate data into virtual worksheet 83, or has directly entered the data into worksheet 83, worker 12 can select (e.g. via button 120 of FIGS. 18A and B, to request generation of a repair estimation.

The software associated with the website, but behind the website in the sense that it cannot be accessed by subscribers, takes the information input by the worker and uses formulas and data stored in databases 32, 34, and/or 36 to compute estimated repair costs for the damage to the automobiles that fall within the range of dent sizes repairable by P.D.R., or which are within the contemplation of the system. The system knows its estimates will be for dents within the range repairable by P.D.R. because template 60 gives the worker a tool to classify the dents and confirm whether within range. However, as mentioned, there may be ancillary repairs that can be estimated, including replacement or repair of trim parts, glass, or other parts.

The Easy Count mode uses the cluster information, as well as the range of smallest to largest dent within the range of sizes 1-4 at reference number 67 of FIG. 60, to predict both the total number of hail dents fixable by P.D.R. and their cost. The program looks to the database(s) and then calculates an estimated total P.D.R. repair cost for the vehicle. As discussed previously, the Easy Count mode is quick and efficient because worker 12 does not have to locate and count each and every dent on vehicle 12. It has been found that the formula and method of the Easy Count mode predicts the total number and type of dents within an acceptable margin of accuracy relative to the actual number and type of dents. Preferable, a cluster is counted on the hood and one on either the roof or trunk lid (see FIG. 7 and FIG. 18). However, only one cluster might be counted (e.g. FIG. 5) or if the only dent(s) is/are to the hood, for example, then only one cluster is, of course, counted and entered.

The parts database 34 allows the estimation software to have immediate access to information about parts that are deemed necessary to replace. The software can therefore add this into the estimation.

The system includes what might be called artificial intelligence. The worksheets prompt the worker 12 what information is needed to create an estimate. Text or other indicia (see FIGS. 16 and 18, reference number 117) on the worksheets can advise or warn worker 12 about things so that the information obtained by worker 12 about a vehicle 14 is complete as possible. By further example, this artificial intelligence can be communicated to worker 12 in instructions 74 (see FIG. 3). An example in FIG. 3 is the suggestion that if total dents within range are less than twenty in number, the “manual count” mode might be more appropriate. By further example, worker 12 is notified about how to check for aluminum panels, which may require a different set of estimation formulas or database information.

Other examples of such built-in intelligence relate to knowledge base 36. Knowledge base 36 can include detailed information about which type of dent and where dents on specific parts or places of the automobile are even eligible to be repaired by P.D.R. For example, there maybe some supporting beam or structure directly underneath a dent in a car hood that cannot be accessed to push that dent out from underneath the hood. The software could inform the subscriber that this repair cannot be performed by P.D.R. but rather must be repaired by more conventional body work. The worker can then be prompted to get or recommend to the insured a conventional body work estimate for that repair work. The software could also inform the worker, the insured, or a client, if certain reported dents, although within the range of conventional P.D.R. sizes, are not fixable by P.D.R. For example, a relatively large dent (in the P.D.R. range of sizes) on a stainless hood can be fixed with P.D.R. The same size dent on an aluminum hood might not be fixable by P.D.R. The software, by referring to the knowledge base, will inform the worker, insured or subscriber accordingly.

Below is a listing of two types of artificial intelligence in the system of the present invention, relative to P.D.R. repair. The first listing are what might be called rules that guide the estimators. The second listing are what might be called failsafes. The system can automatically take some action (e.g. decline to calculate or print an estimate, alert the user, pause or break its processing, etc.) if a listed event occurs:

(a) Dent Estimators Rules for P.D.R Estimation:

1. Do not estimate a panel if it has a dent within ¼ in. of the edge of that panel.

2. Do not estimate a vehicle if the paint is in poor shape.

3. Do not estimate a panel if you find a crack in the paint of that panel.

4. Do not estimate the roof around the sunroof area, if there is a dent within ½ in. area around the sunroof, unless it is a size #2 dent or smaller.

5. Do not estimate vehicles that are older than 1992.

6. If you find a very sharp dent on a panel, refer to the training section of the program to help you decide if P.D.R. should be attempted on that panel.

7. Do not estimate large or long crease type dents. If you are not sure refer to the training section of the Dent Estimators program.

8. Do not estimate dents larger than size #3 on the rails of a pick-up bed.

9. Do not estimate dents larger than size #2 on an aluminum panel.

10. Do not try to estimate dents larger than a #4 on a vehicle, unless you are giving a “door ding” estimate.

(b) Fail Safes Built into the Dent Estimators Program.

These generally force on estimator to follow the software's parameters, and if the software sees any indication the estimation process parameters, the system will not allow it:

1. The estimate wizard will guide the appraiser through every step of the estimate.

2. The estimate wizard will not allow the appraiser to exceed a cost limit placed on each panel by the program.

3. No estimate can occur on a panel, if the amount of damage exceeds the limit placed on that panel by the estimate program.

4. No estimate will occur if the dent count in the “Easy Count” method exceeds a limit placed on the number of dents by the estimate program.

5. The estimate wizard will give “Panel Alerts!” (see reference number 117) to the appraiser, if there is an access problem on a vehicle for P.D.R. Another type of information to the estimator can be communicated such as shown in FIG. 21.

6. The estimate wizard will give Panel Alerts! to the appraiser if aluminum panels are detected by Dent Estimators.

7. The estimate wizard will recommend to the appraiser the dent size to be estimated, on certain models of vehicles.

In the above-described “Easy Count” mode, the software literally requires only the range between smallest and largest dent and information about how many dents exist in a cluster of P.D.R. sized dents to estimate cost of repair. This is a type of fail safe or automatic rule or control by the system. It does not require that each and every dent on the car or even on any section of the car be individually counted. It has been found that such estimations are adequately accurate even without knowing or requiring knowledge of the exact number and sizes of dents for each part of the car. Particularly for hail damage, just those two pieces of information allow extrapolation of total needed P.D.R. and the type and cost of P.D.R. for the car.

The software then can display a report that gives estimated repair cost for the type of dents it determines are repairable by P.D.R. for each part or several parts of the vehicle. This report can be used to prepare an estimation for the car owner or the insurance company, can be downloaded or printed out, or otherwise manipulated as permissions exist.

FIGS. 17 and 19 shows two examples of such reports. Identifying information about the vehicle and customer from database 32 are included. A description of the location of damage, its estimated labor time for P.D.R., and an estimated cost for each part of the vehicle are set forth. Any replacement parts, labor costs for replacement and parts cost are set forth. Finally, the report includes total estimated cost, including total labor time, total cost, and tax; and a grand total estimated cost.

These reports can be displayed to worker 12, client 44, or anyone else have authorized access. The reports can be downloaded or printed out by authorized persons. For example, once generated, a report could be printed out at the estimation location 10 and handed to the insured. Here FIGS. 17 and 19 are manual and easy count reports for the same vehicle and the same vehicle damage. Note how close the estimates are, even though the easy count mode does not count every dent susceptible of P.D.R. However, easy count is very quick and appears to correlate well with manual counts.

The software could also store the report electronically, or otherwise store information about the particular estimate for that vehicle for archival purposes for a client. It could also automatically notify a client that an estimate for an insured, for example, has been completed, and either sends the estimate to the client or to any designated address via fax or email. The client, such as insurance company, could correlate the report with an insured and a policy, and then act upon the event, such as generating a check for the insured and updating accounting, underwriting, and policy records accordingly.

Of course, various types of reports can be generated. The type and amount of details can be selected and vary according to need or desire.

Thus, the above methodology provides a simple and uniform way of data gathering related to damage to the automobile, and a quick and easily accessible estimation report. It is believed that this will cut the time required for investigating the car as well as increase the uniformity and reliability of estimations of P.D.R. type repairs.

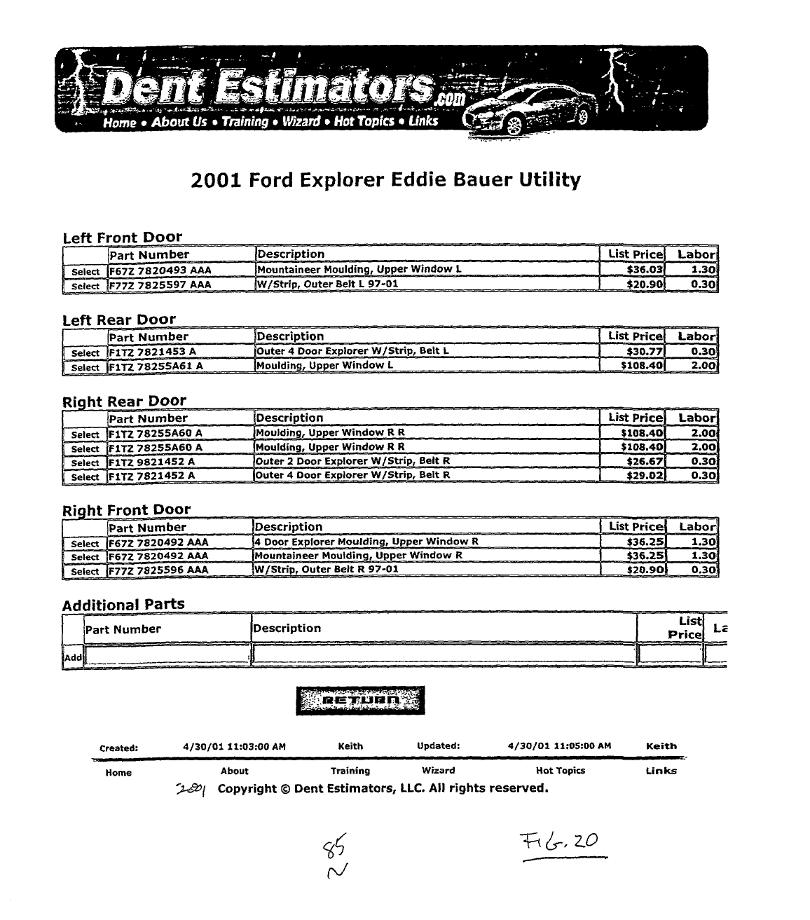

The other protocol or mode for estimation is called the “manual count” mode. The differences from the “Easy Count” mode described above are apparent by referring to the description at the top half of instructions 74 at FIG. 3. The manual count mode of the invention does involve counting individual dents. It is similar to easy count mode except that template 60 and record sheet 72 (FIG. 6) and/or virtual record sheet 81 (FIGS. 16A and B) are used to record the precise number of dents for each part of the automobile (but still within the range of P.D.R. type repairs). This information is then input into virtual record or worksheet 81 at the website. The software uses it to prepare repairs estimates. Manually counted dent totals, input to database 32 (see reference number 122) at table 32 in FIG. 8, are used to make the estimation. In manual mode, the number of dents, correlated to size within the range of template holes 62-65, can be used to directly estimate cost of repair, for example, using the stored tables. Also, parts database 34 and knowledge base database 36 can be used for the particular make and model of car. The estimate is usually broken down for each of several parts of the cars (left front fender, right front fender, hood, roof, etc.) (see also FIG. 20).

Source code can be written with the following principles. Initialization and set-up of the variables takes place and database connection is made. The variables are populated with fields from the database(s).

As further described below, a discount associated with dent size can be determined and applied in the estimate. The discount is a percentage. The discount is the value of the difference of the maximum dent size and the minimum dent size. The discount may be relatively small but reflects that different dent size tables are used to compute costs. The appropriate dent size table is selected based on the largest dent size.

There is also a cost associated with the first dent, the larger the dent, the higher the cost. The cost (in terms of effort, time, and resources of the first dent being higher the larger the dent (e.g. 60, 55, 50, 45 for dents of size 4, 3, 2, 1, respectively).

Below is a more specific description of the steps within the estimation calculation step 105 of the software.

(3) Dent Estimators Estimation System Specifications

The first step is to determine the appropriate cost discount based on the variance of the size of dents observed. Identifying that the variance in the size of the dents affects the overall cost for the estimate, the discount is calculated by determining the difference of the smallest and largest dents size divided by 100. For example, if dent size 1 is selected and dent size 4 is selected, the discount would be: (4−1)/100=3%. The reason for such a cost discount is that the smaller the dent, usually the quicker and easier the P.D.R. repair, and thus, that advantage is reflected in the discounting. However, it does not have to be applied.

If the Manual Count method is selected the system will then determine the cost of the initial dent per the largest dent based on the following:

a. If dent size 4 is selected the first dent cost=$60.00

b. If dent size 3 is selected the first dent cost=$55.00

c. If dent size 2 is selected the first dent cost=$50.00

d. If dent size 1 is selected the first dent cost=$45.00

This initial dent cost is much higher than the average cost per dent for multiple dents, and is used because the whether there is one dent to repair or many, there is an initial overhead and expense that must be recaptured.

Next, the number of panels that have been selected is calculated. This value is used later in Manual Count process to distribute the cost of the initial dent across each of the selected panels. Assuring that the cost of the initial dent is distributed proportionally. Distribution of costs across all panels allows an easy comparison between P.D.R. repair estimation and replacement of the panel.

Based on the input of the client, the estimation based upon the appropriate method, either Easy Count or Manual Count, is then processed.

If Easy Count:

i. Calculate the total number of dents observed by adding the number of dents in the hood ring and roof/trunk ring. It is many times preferred to count two clusters, one on the hood and one on either the roof or the trunk. However, one cluster count from hood, roof, or trunk lid can work.

ii. Calculate the overall number of dents by multiplying the dent factor by the total number of observed dents. The dent factor is a multiplier that is derived from experience in P.D.R. It allows just the one or two cluster counts from relatively small locations on the car to be extrapolated into estimated number of dents for the whole car, particularly used in hail damage situations. In this embodiment the dent factor is the number 42. However, it may change based on factors. For example, there may a different dent factor applied for hail damage in different geographic regions, or depending on the make and model of car. Here one dent factor, the value 42, is used for all easy count estimations.

iii. Based upon the total number of dents observed and largest dent size observed, determine the cost per dent based on the schedule in Chart 1 below:

Dent Estimators Estimation System Specifications
Chart 1
Easy Count Cost Schedule

| Dent Size | # of Dents | Cost Per Dent |
|---|---|---|
| 1 | 1 | $17.00 |
| 1 | 2 | $16.00 |
| 1 | 3 | $12.00 |
| 1 | 4 | $10.00 |
| 1 | 5 | $9.00 |
| 1 | 6 | $8.00 |
| 1 | 7 | $7.00 |
| 1 | 8 | $6.50 |
| 1 | 9 | $6.00 |
| 2 | 1 | $20.00 |
| 2 | 2 | $16.50 |
| 2 | 3 | $13.00 |
| 2 | 4 | $10.50 |
| 2 | 5 | $9.50 |
| 2 | 6 | $8.50 |
| 2 | 7 | $7.50 |
| 2 | 8 | $7.25 |
| 2 | 9 | $6.50 |
| 3 | 1 | $24.00 |
| 3 | 2 | $17.00 |
| 3 | 3 | $14.00 |
| 3 | 4 | $11.00 |
| 3 | 5 | $10.00 |
| 3 | 6 | $9.00 |
| 3 | 7 | Unable to |
| | | estimate |
| 3 | 8 | Unable to |
| | | estimate |
| 3 | 9 | Unable to |
| | | estimate |
| 4 | 1 | $30.00 |
| 4 | 2 | $20.00 |
| 4 | 3 | $16.00 |
| 4 | 4 | $14.00 |
| 4 | 5 | $12.00 |
| 4 | 6 | Unable to |
| | | estimate |
| 4 | 7 | Unable to |
| | | estimate |
| 4 | 8 | Unable to |
| | | estimate |
| 4 | 9 | Unable to |
| | | estimate |

iv. Calculate the total cost of the estimate by multiplying the cost per dent by the overall number of dents.

v. Discount the total cost of the estimate based upon the discount factor calculated earlier.

vi. Distribute the estimate total by the percentages identified in Chart 2 below:

Dent Estimators Estimation System Specifications
Chart 2
Easy Count Panel Distribution Percentages

| | Distribution |
|---|---|
| Panel | Percentage |
| Left Front Fender | 6% |
| Left Front Door | 5% |
| Left Rear Door | 5% |
| Left Rear Quarter | 8% |
| Right Rear Quarter | 8% |
| Right Rear Door | 5% |
| Right Front Door | 5% |
| Right Front Fender | 6% |
| Hood | 16% |
| Top | 24% |
| Deck/Trunk | 12% |

vii. If the hood or deck/trunk is selected and the material is aluminum, an additional cost is calculated by multiplying the total cost of the panel by 50%.

viii. Calculate the hourly labor rate for each panel by dividing the total cost for each panel by the labor rate entered by the client.

ix. Adding any additional considerations to the estimate based upon the following schedule:

1. 1 Piece Headliner R & I ($100.00)

2. Glued Headliner ($125.00)

3. Sunroof ($65.00)

4. Moldings, Cowl, Sail, etc. ($150.00)

x. The client has the ability to add specific parts to the estimate by selecting the individual parts from the vehicle database. Manufactures and distributors set the cost of the each part.

If Manual Count:

i. Distribute the cost of the first dent as described in chart 3 below:

Dent Estimators Estimation System Specifications
Chart 3
Manual Count Panel Distribution Percentages

| | Distribution |
|---|---|
| Panel | Percentage |
| Left Front Fender | 30% |
| Left Front Door | 25% |
| Left Rear Door | 25% |
| Left Rear Quarter | 40% |
| Right Rear Quarter | 40% |
| Right Rear Door | 25% |
| Right Front Door | 25% |
| Right Front Fender | 30% |
| Hood | 80% |
| Top | 120% |
| Deck/Trunk | 60% |

ii. Calculate the cost of each panel by multiplying the number of dents entered for each panel based upon the schedule in Chart 4 below:

Dent Estimators Estimation System Specifications
Chart 4
Manual Count Cost Schedule

| Dent Size | # of Dents | Cost Per Dent |
|---|---|---|
| 1 | 1-8 | $14.00 |
| 1 | 9-16 | $17.00 |
| 1 | 17-25 | $12.15 |
| 1 | 26-33 | $10.20 |
| 1 | 34-42 | $9.00 |
| 1 | 43-50 | $8.06 |
| 1 | 51-59 | $7.00 |
| 1 | 60-67 | $6.50 |
| 1 | 68-76 | $6.00 |
| 2 | 1-8 | $17.50 |
| 2 | 9-16 | $17.33 |
| 2 | 17-25 | $13.10 |
| 2 | 26-33 | $10.70 |
| 2 | 34-42 | $9.50 |
| 2 | 43-50 | $8.57 |
| 2 | 51-59 | $7.50 |
| 2 | 60-67 | $7.27 |
| 2 | 68-76 | $6.47 |
| 3 | 1-8 | $21.00 |
| 3 | 9-16 | $17.85 |
| 3 | 17-25 | $14.12 |
| 3 | 26-33 | $11.20 |
| 3 | 34-42 | $10.00 |
| 3 | 43-50 | $9.08 |
| 3 | 51-59 | Unable to |
| | | estimate |
| 3 | 60-67 | Unable to |
| | | estimate |
| 3 | 68-76 | Unable to |
| | | estimate |
| 4 | 1-8 | $27.43 |
| 4 | 9-16 | $21.00 |
| 4 | 17-25 | $16.13 |
| 4 | 26-33 | $14.25 |
| 4 | 34-42 | $12.00 |
| 4 | 43-50 | Unable to |
| | | estimate |
| 4 | 51-59 | Unable to |
| | | estimate |
| 4 | 60-67 | Unable to |
| | | estimate |
| 4 | 68-76 | Unable to |
| | | estimate |

iii. If the hood or deck/trunk is selected and the material is aluminum, an additional cost is calculated by multiplying the total cost of the panel by 50%.

iv. Calculate the hourly labor rate for each panel by dividing the total cost for each panel by the labor rate entered by the client.

v. Adding any additional considerations to the estimate based upon the following schedule:

1.1 Piece Headliner R & I ($100.00)

2. Glued Headliner ($125.00)

3. Sunroof ($65.00)

4. Moldings, Cowl, Sail, etc. ($150.00)

vi. The client has the ability to add specific parts to the estimate by selecting the individual parts from the vehicle database. Manufactures and distributors set the cost of the each part.

All data/information calculated through the estimation process is stored in the SQL Server database.

The system will generate a printable estimate. Examples are shown at FIGS. 17 (manual count) and 19 (easy count).

As can be seen, the number of panels indicated as damaged are counted by the software and a dent deduction based on the number of panels is determined. During the initial stages of the program, there is no amount associated with the deduction, the program is just keeping track of which panels for which there will be a deduction.

The process continues but differs depending on whether the Easy Count or Manual Count mode is selected. In the case of Easy Count mode, this part of the program calls a function “easy count”. The easy count function has its parameters as a table to use, the table associated with the largest dent size (e.g. within the range of dent sizes 62-65 on template 60), and a dent total. The dent total corresponds to the number of dents, e.g., the number of dents inside opening 66 in template 60. For example, dent total 1 is associated with 1 to 8 dents, dent total 2 is associated with 9 to 16 dents, dent total 3 is associated with 17 to 25 dents, dent total 4 is associated with 26 to 33 dents, dent total 5 is associated with 34 to 42 dents, dent total 6 is associated with 43 to 50 dents, dent total 7 is associated with 51 to 59 dents, dent total 8 is associated with 60 to 67 dents, and dent total 9 is associated with 68 to 76 dents. The easy count mode receives the maximum dent size and the number of dents in a selected cluster and in this table associated with the maximum size looks up the cost associated with a particular number of dents. The cost is a cost per dent.

A total estimate is calculated from which a discount can be taken. The total estimate is simply a dollar amount (e.g. $42.00) multiplied by the size of the largest dent (1 through 4) multiplied by the amount from the table. The discount is then calculated if required.

The hours associated with repair are also calculated by taking the amount associated with a particular panel once calculated and dividing that by an hourly labor rate (e.g. $40/hr).

In the Manual Count mode, the program takes the table associated with the largest size dent (tables 1 through 4) and the precise number of dents. The precise number of dents is multiplied by the amount per dent in a corresponding table to determine a total estimate. The estimates are performed for each panel and a number of hours based on the estimate divided by an hourly labor rate (e.g. $50 per hour) is also calculated.

Of course, a variety of alternatives in the way the programming functions and the particular values used can vary.

Once the calculations made by the software are completed for either mode, they are added to the database.

Thus, P.D.R. estimations can be obtained via a wide area network by entering on a worksheet the information required by one of the two modes of the software. In this embodiment, assistance is given by use of template 60 and the record sheet(s) the worker uses while examining the automobile.

H. Options and Alternatives

The previously described embodiments are exemplary only and not intended to limit the scope of the invention. Variations obvious to those skilled in the art are included in the invention. Examples include the following.

Record sheets 70 or 72 could be filled out manually by the worker. Alternatively, a hand-held digital device such as a PALM PILOT or portable PC could allow direct entry of data into virtual record sheets 76, 77, 80, 81-84. The mode of data entry can vary. Another example is voice recognition data entry.

Template 60 illustrated at FIG. 4 is an 8½″ by 11″ laminated paper apparatus. Template 60 could take different forms. For example, it could be merely paper. It could disposable. It could come in a pad or tablet form with multiple sheets. Further, it could be projected optically or by other means onto car 14 instead of being a sheet-like apparatus. It could be used individually to assist an estimator in characterizing or making estimations of P.D.R. type damage, with or without the software and databases described herein.

The software of the described exemplary embodiments could be made to be interfaced with external computer systems and software, such as internal software of clients, such as insurance companies. The estimates according to the exemplary embodiments can then be shared with those other computer systems. For example, information from the estimation system's website could be transferred to a subscriber insurance company's main frame computer by a FDP dump. The internal records of an insurance company can be updated relative to an insured's estimated damage. Details about the damage to the insured's vehicle could be stored. The insurance company could automatically issue correspondence and even a check to the insured once the estimate is confirmed and pay out is authorized. A check could even be printed at the estimation location 10. Processing speeds could be quite fast, literally issuing a report and/or check to the insured at the estimation location 10 within seconds of the request of estimation. Other integrations of the information and results of the exemplary embodiments with a client such as an insurance company, are possible.

The invention can be accessible on a subscription basis. Clients could pay a required fee or subscription and get access to certain aspects of the invention. Different levels of access are possible based on the level of subscription. Level of access can be controlled by passwords or other methods such as are known in the art. Different clients could have different levels of access.

The data obtained by the present system could be stored and “mined” for information. For example, it could provide valuable information to the insurance industry regarding such things as geographic areas having the most frequent hail storms. This could help fine-tune underwriting of insurance policies. Other “mining” or analysis of the data could be valuable.

As indicated at FIGS. 10-21, with buttons on the screen displays, other modes or adjunct tools or applications are possible with the estimation software. For example, on line training can be available (see FIG. 10, ref. no. 90). The training could include information about how to use the estimation protocols or the website. It could also include training about the parts database and knowledge base data base. It could even contain training on P.D.R. generally.

Further, as shown, the website could contain other information. Examples are links (see, e.g., FIG. 10) to other web sites or resources, information about the software or subscription to it, or other tools or applications. Wizards, such as are known in the art (see, e.g. FIG. 10, ref. no. 91), like the electronic worksheets or forms of FIGS. 11-21, can guide the user.

The host 40 could continuously update the databases to keep current. This would allow all users of the system to have up to date information.

The method of delivery of the system according to the invention can vary. The example discussed above focuses upon use of a global computer network with remote computers and a central computer or server. Alternatively, the application programming and databases could be recorded on one or more CD-ROMs and distributed to authorized users. Each user would then have a complete estimation system on-board a local computer. Periodic updates of the CD-ROMs could keep the information current.

The system can be implemented and work with a number of different devices. It is believed that almost any internet appliance could be used. The system could be implemented in a LAN or WAN or other type of network other than the internet. It is believed it can run on a variety of operating systems.

What is claimed is:

1. A method of estimating cost of paintless dent repair of automobile body damage susceptible of the same comprising: (a) gathering information about body damage susceptible of P.D.R. of an automobile; (b) processing the information according to a pre-existing estimation program; (c) generating an estimate of repair costs based on the information.

2. The method of claim 1 further comprising the processing includes use of stored digital data.

3. The method of claim 1 further comprising sending the information via a global computer network to a server.

4. The method of claim 1 wherein the step of information gathering comprises confirming the damage is susceptible of P.D.R.

5. The method of claim 4 wherein the damage is one or more dents.

6. The method of claim 4 wherein the step of information gathering further comprises characterizing the dent or dents over a range of sizes of damage susceptible of P.D.R.

7. The method of claim 5 further comprising identifying a cluster of dents and characterizing the cluster.

8. The method of claim 7 wherein the characterizing of the cluster comprises confirming the cluster is contained with a predetermined area and counting the number of dents in that predetermined area.

9. The method of claim 7 further comprising using the range of dent sizes and cluster information to estimate total cost of repair for the vehicle.

10. The method of claim 1 wherein the step of gathering information includes manual counting damage susceptible of P.D.R. repair and using that information to generate a repair estimation.

11. The method of claim 10 wherein the damage is one or more dents.

12. The method of claim 1 further comprising requesting a web page hosted by a web server, the web server including a data input template.

13. The method of claim 12 further comprising communicating the damage information by completing the data input template.

14. An apparatus for estimating cost of paintless dent repair of automobile body damage susceptible of the same comprising: (a) a device to record information about body damage susceptible of P.D.R. of an automobile based on a characterization of the damage; (b) a computer having a data input adapted to digitally store said information about body damage; (c) a computer with an application program adapted to receive and process said data input and generate an estimation report based on said input data.

15. The apparatus of claim 14 wherein said computer comprises a first computer for data input and a second computer with the application program.

16. The apparatus of claim 14 wherein said device to record information is a worksheet including indicia to prompt recordation of certain information.

17. The apparatus of claim 16 wherein said worksheet is a physical worksheet.

18. The apparatus of claim 16 wherein said is an electronic versions displayable on a display of said first computer.

19. The apparatus of claim 16 wherein said worksheet comprises a physical worksheet and an electronic version.

20. The apparatus of claim 14 wherein said characterization of damage relates to one or more dents over a range of sizes of damage susceptible of P.D.R.

21. The apparatus of claim 14 wherein said characterization of damage includes characterizing a cluster of dents, confirming the cluster is contained with a predetermined area, and counting the number of dents in that predetermined area.

22. The apparatus of claim 21 further comprising using the range of dent sizes and cluster information to estimate total cost of repair for the vehicle.

23. The apparatus of claim 14 wherein gathering information includes manual counting damage susceptible of P.D.R. repair and using that information to generate a repair estimation.

24. The apparatus of claim 14 further comprising data on a storage medium that is readable by the computer and used to create the estimation.

25. The apparatus of claim 14 further comprising a connection to a global computer network.

26. An apparatus for estimating cost of paintless dent repair of automobile body damage susceptible of the same comprising: (a) a hand carryable and manipulatable device having a length, width and thickness; (b) a plurality of openings in the device of varying areas correlated to a range of areas; (c) a first opening of the plurality of openings defining a designated smallest dent size susceptible of P.D.R. and a second opening of the plurality of opening defining a designated largest dent size susceptible of P.D.R.

27. The apparatus of claim 26 wherein said device comprises a sheet of material.

28. The apparatus of claim 27 wherein the material has a degree of flexibility.

29. The apparatus of claim 28 wherein the material is a paper.

30. The apparatus of claim 28 wherein the material is paper laminated with plastic.

31. The apparatus of claim 28 wherein the material is plastic.

32. The apparatus of claim 27 wherein the width, length and thickness of the sheet are similar to letter sized paper.

33. The apparatus of claim 26 further comprising indicia on the device uniquely identifying the plurality of openings.

34. The apparatus of claim 26 wherein the plurality of openings are arranged in order of next closest area to the one preceding.

35. The apparatus of claim 26 wherein the smallest opening is on the order of 1½ inches squared to 2½ inches squared.

36. The apparatus of claim 26 further comprising an opening substantially larger than any of the plurality of openings, correlated to a predetermined area.

37. The apparatus of claim 36 wherein the predetermined area is correlated to measuring a cluster of dents, the number of dents in a cluster of dents within said predetermined area being adapted to be used to predict total number of dents on a part or all of a vehicle.

38. The apparatus of claim 37 wherein the dents are hail damage dents.

39. The apparatus of claim 26 wherein the device is adapted to project one or more of said openings onto a vehicle.

40. The apparatus of claim 39 wherein the device includes a light source which projects through light or shadows images of at least one of said openings onto a vehicle.

41. The apparatus of claim 39 wherein the device comprises a plurality of separate devices, each having one of said openings.

42. The apparatus of claim 26 wherein the device has one or more adjustable sized openings.

43. The apparatus of claim 26 in combination with a worksheet containing indicia related to P.D.R. estimation.

44. The apparatus of claim 43 wherein the worksheet is electronic.

45. A kit for estimating cost of paintless dent repair of automobile body damage susceptible of the same comprising: (a) a hand carryable and manipulatable device having a length, width and thickness, the device having a plurality of openings in the device of varying areas correlated to a range of areas; a first opening of the plurality of openings defining a smallest dent size susceptible of P.D.R. and a second opening of the plurality of opening defining a largest dent size susceptible of P.D.R.; (b) a recording medium having indicia prompting a user to record a set of identifying information about the vehicle and a set of characterizing information about damage to the vehicle.

46. The kit of claim 45 wherein the device and the record sheet are sized generally the size of letter sized paper.

47. The kit of claim 45 wherein the device further comprises an opening larger than the plurality of openings adapted to characterize a cluster of dents in a vehicle.

48. The kit of claim 45 further comprising an instruction sheet.

49. The kit of claim 48 wherein the instruction sheet includes written instructions relating to a plurality of methods of dent estimation.

50. The kit of claim 49 wherein the method of dent estimation utilizes either characterizing information from the plurality of openings and characterizing information from the larger opening or characterizing information from the plurality of openings and an actual count of dents and characterization of size of dents.

51. A subscriber-based system for estimating cost of paintless dent repair of automobile body damage susceptible of the same comprising: (a) a server adapted to host a web site, the web site being password accessible according to a level of authorization, the server being in communication with a database containing information characterizing damage to an automobile; (b) a subscriber computer adapted for connection to the web site via a global computer network; (c) access to information in the database being dependent on a level of authorization given to a subscriber for compensation.
